(19) United States
(12) Patent Application Publication
(10) Pub. No.: US 2014/0085570 A1
(43) Pub. Date: Mar. 27, 2014

(54) BACKLIGHT AND LIQUID CRYSTAL DISPLAY DEVICE

(71) Applicants: Muneharu Kuwata, Tokyo (JP); Rena Nishitani, Tokyo (JP); Nami Nakano, Tokyo (JP); Kuniko Kojima, Tokyo (JP)

(72) Inventors: Muneharu Kuwata, Tokyo (JP); Rena Nishitani, Tokyo (JP); Nami Nakano, Tokyo (JP); Kuniko Kojima, Tokyo (JP)

(73) Assignee: MITSUBISHI ELECTRIC CORPORATION, Tokyo (JP)

(21) Appl. No.: 14/123,025

(22) PCT Filed: Mar. 14, 2012
(86) PCT No.: PCT/JP2012/001758

§ 371 Date: Nov. 27, 2013

(30) Foreign Application Priority Data
May 31, 2011 (JP) 2011-122217

(51) Int. Cl. G02F 1/1335; F21V 8/00

(52) U.S. Cl. CPC G02F 1/133615; G02B 6/005
USPC 349/65

(57) ABSTRACT

An objective is to obtain a backlight in which a decrease in brightness at a peripheral portion associated with the change of viewing distance is reduced. The backlight is comprised with an optical member 107 for transforming beams projected from light sources 117A and 117B into beams having a narrow-angle light distribution in which rays having intensity of no less than a predetermined value are localized within a predetermined angle range centered in the normal direction of a display surface 106b of a liquid crystal display panel 106, and for projecting the transformed beams in the direction of the liquid crystal display panel 106; and a light distribution control member 83 for receiving the beams that are projected from the optical member 107 and that have the narrow-angle light distribution, and for projecting the received beams in the direction of the liquid crystal display panel 106, wherein a plurality of concaves 109 are provided at the light distribution control member 83 for transforming a beam, from among the beams having the narrow-angle light distribution, that enters a peripheral portion of the liquid crystal display panel 106 so that the narrow-angle light distribution of the entered beam is broadened compared to that of a beam that enters a central portion of the liquid crystal display panel 106; and curvature radiuses of the plurality of concaves are formed so that a curvature radius of a concave located at a peripheral portion of the light distribution control member 83 is smaller than a curvature radius of a concave located at a central portion of the light distribution control member 83.

### TECHNICAL FIELD

The present invention relates to a backlight used in liquid crystal display devices and a liquid crystal display device equipped with the backlight.

### BACKGROUND ART

In general, a liquid crystal display device of transmissive type or semi-transmissive type is equipped with a liquid crystal display panel having a liquid crystal layer and a backlight for projecting beams toward a rear surface of the liquid crystal display panel. Previously, a liquid crystal display device of narrow viewing angle type has been proposed, in which an emission beam distribution is narrowed by providing a prism sheet at the beam emission surface side of a light guide plate of the backlight for the purpose of reducing power consumption, increasing brightness, protecting privacy, and the like (for example, see Patent Document 1).

In the above-described liquid crystal display device of narrow viewing angle type, the emission beams projected from a display surface of the liquid crystal display panel have high directivity all over the display surface in the normal direction of the display surface. Therefore, when viewed at close range, there has been a problem that brightness at a peripheral portion of the liquid crystal display panel is greatly reduced compared to that at a central portion, depending on the difference of angles into which the liquid crystal display panel is looked. This tendency becomes prominent as the viewing distance decreases and as the size of the liquid crystal display panel increases, and, in an extreme case, the brightness of the peripheral portion becomes too low to be able to visually recognize.

In order to solve this problem, a configuration is proposed in which a sheet is provided at the beam emission surface side of a light guide plate of a backlight. Here, the sheet has a prism whose cross section is a triangular shape and that has ridgelines arranged so as to make a principal ray of beams, which are emitted from an arbitrary position of a beam emission surface of the backlight, to be oriented to the direction of a predetermined viewing point (for example, see Patent Document 2).

### PRIOR ART DOCUMENTS

### Patent Documents

Patent Document 1: Japanese Unexamined Patent Application Publication No. 2001-143515

Patent Document 2: Japanese Unexamined Patent Application Publication No. H07-318729

### SUMMARY OF THE INVENTION

### Problem that the Invention is to Solve

In the above-described backlight, because a principal ray of beams projected from a beam emission surface is oriented toward a predetermined viewing point, while uniform brightness is observed when viewed from the predetermined viewing point, uniform brightness is not observed when viewed from a position deviated from the predetermined viewing position. Thus, there has been a problem that brightness at a peripheral portion is reduced as a viewing distance changes.

The present invention has been made in order to solve the above-described problem, and an objective thereof is to obtain a backlight and a liquid crystal display device in which a decrease in brightness at a peripheral portion associated with the change of viewing distance is reduced.

### Means for Solving the Problem

A backlight according to the present invention is comprised with a light source; an optical member for transforming beams projected from the light source into beams having a narrow-angle light distribution in which rays having intensity of no less than a predetermined value are localized within a predetermined angle range centered in the normal direction of a display surface of a liquid crystal display panel, and for projecting the transformed beams in the direction of the liquid crystal display panel; and a light distribution control member for receiving the beams that are projected from the optical member and that have the narrow-angle light distribution, and for projecting the received beams in the direction of the liquid crystal display panel, wherein a plurality of curved surfaces are provided at the light distribution control member for each transforming a beam, from among the beams having the narrow-angle light distribution, that enters a peripheral portion of the liquid crystal display panel so that the narrow-angle light distribution of the entered beam is broadened compared to that of a beam that enters a central portion of the liquid crystal display panel; and curvature radiuses of the plurality of curved surfaces are formed so that a curvature radius of a curved surface located at a peripheral portion of the light distribution control member is smaller than a curvature radius of a curved surface located at a central portion of the light distribution control member.

### Advantageous Effects of the Invention

In a backlight according to the present invention, a decrease in brightness at a peripheral portion associated with the change of viewing distance can be reduced.

### BRIEF DESCRIPTION OF DRAWINGS

FIG. 1 is a diagram schematically showing a configuration of a liquid crystal display device in Embodiment 1.

FIG. 2 is a perspective view of FIG. 1.

FIG. 3 is a diagram schematically showing a configuration of a liquid crystal display device in Comparative Example 1.

FIG. 4 is a diagram schematically showing a configuration of a liquid crystal display device in Comparative Example 2.

FIG. 5 is a diagram enlargedly showing a part of a light distribution control member in the liquid crystal display device in Embodiment 1.

FIGS. 6 and 7 are diagrams enlargedly showing a part of a light distribution control member in a liquid crystal display device in a variant of Embodiment 1.

FIG. 8 is a diagram schematically showing a configuration of a liquid crystal display device in Embodiment 2.

FIG. 9 is a diagram schematically showing a configuration of a liquid crystal display device in Embodiment 3.

FIG. 10 is a diagram enlargedly showing a part of a light distribution control member in the liquid crystal display device in Embodiment 3.

FIG. 11 is a diagram enlargedly showing a part of a light distribution control member in a liquid crystal display device in Embodiment 4.

FIG. 12 is a diagram schematically showing a configuration of a liquid crystal display device in Embodiment 5.

FIG. 13 is a diagram enlargedly showing a part of a light distribution control member in the liquid crystal display device in Embodiment 5.

FIG. 14 is an explanatory diagram for calculating an angle formed between an X-Y plane and each of optical surfaces of the light distribution control member in the liquid crystal display device in Embodiment 5.

FIG. 15 is a diagram schematically showing a configuration of a liquid crystal display device (liquid crystal display device of transmissive type) in Embodiment 6 according to the present invention.

FIG. 16 is a diagram schematically showing a part of the configuration of the liquid crystal display device in FIG. 15 when viewed from the Y-axis direction.

FIG. 17 is a diagram schematically showing an optical configuration example of a light guide plate in a first backlight unit according to Embodiment 6.

FIG. 18 is a graphic chart showing a calculated result of simulation on light distribution of an emission beam projected from the light guide plate shown in FIG. 17.

FIG. 19 is a diagram schematically showing an optical configuration example of a downward prism sheet in the first backlight unit according to Embodiment 6.

FIG. 20 is a graphic chart showing a calculated result of simulation on light distribution of an illumination beam projected from the downward prism sheet.

FIG. 21 is a diagram schematically showing optical characteristics of microscopic optical elements formed on a rear surface of the downward prism sheet.

FIG. 22 is a diagram schematically showing an optical configuration example of an upward prism sheet in the first backlight unit according to Embodiment 6.

FIG. 23 is a diagram schematically showing an optical function of microscopic optical elements formed on a front surface of the upward prism sheet.

FIG. 24 is a diagram schematically showing an optical function of the microscopic optical elements of the upward prism sheet when the array direction of the microscopic optical elements of the upward prism sheet is coincided with the array direction of the microscopic optical elements of the downward prism sheet.

FIG. 25 is a graphic chart showing a measured result of light distribution of an illumination beam projected from a backlight unit.

FIG. 26 is a graphic chart showing another measured result of light distribution of the illumination beam projected from a backlight unit.

FIG. 27 is a diagram schematically exemplifying three types of light distribution of the illumination beam.

FIG. 28 is a diagram schematically showing an example of three types of viewing angle control.

FIG. 29 is a diagram schematically showing a configuration of a liquid crystal display device (liquid crystal display device of transmissive type) in Embodiment 7 according to the present invention.

FIG. 30 is a diagram schematically showing a part of the configuration of the liquid crystal display device in FIG. 29 when viewed from the Y-axis direction.

FIG. 31 is a cross-sectional view enlargedly showing a part of a light distribution control member in a liquid crystal display device in Embodiment 8.

FIG. 32 is a cross-sectional view enlargedly showing a part of a light distribution control member in a liquid crystal display device in Embodiment 9.

FIG. 33 is a cross-sectional view enlargedly showing a part of a light distribution control member in a liquid crystal display device in Embodiment 10.

### MODE FOR CARRYING OUT THE INVENTION

### Embodiment 1

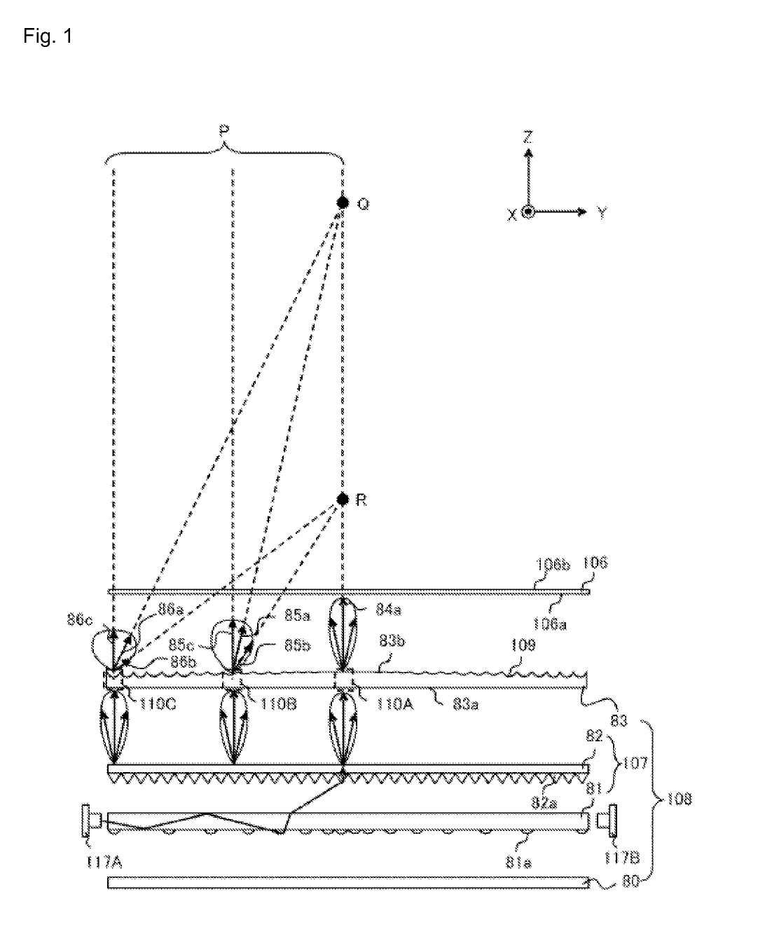

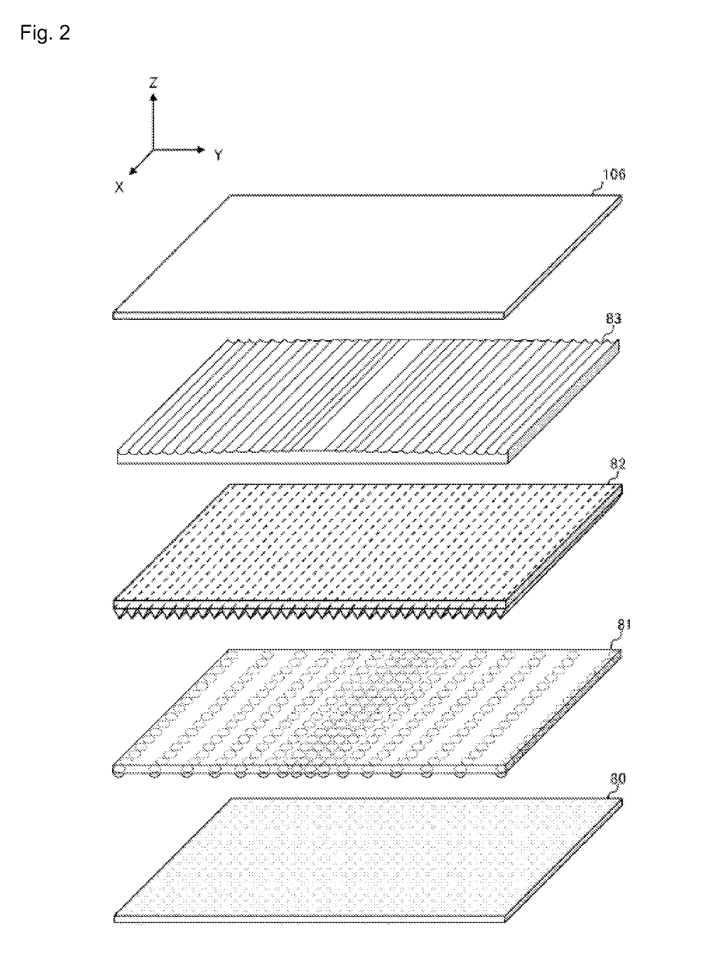

FIGS. 1 and 2 are diagrams showing a liquid crystal display device in Embodiment 1. FIG. 1 is the diagram schematically showing a configuration of the liquid crystal display device, and FIG. 2 is a perspective view of the liquid crystal display device in FIG. 1.

As shown in FIGS. 1 and 2, the liquid crystal display device includes a liquid crystal display panel 106 of transmissive type and a backlight 108 for projecting beams toward a rear surface 106a of the liquid crystal display panel 106.

The liquid crystal display panel 106 has the rear surface 106a and a display surface 106b, and the display surface 106b is provided to be parallel to the X-Y plane that includes the X-axis and Y-axis which are orthogonal to the Z-axis. The normal direction of the display surface 106b is parallel to the Z-axis, and the X-axis and Y-axis are mutually orthogonal.

The backlight 108 includes a light distribution control member 83, an optical member 107 comprised with a downward prism sheet 82 (optical sheet) and a light guide plate 81, a light reflection sheet 80, and light sources 117A and 117B.

The light sources 117A and 117B are provided face to face with both end surfaces (incident edge surfaces) of the light guide plate 81 in its Y-axis direction, respectively, and are configured with, for example, plural laser-emitting devices or light-emitting diodes arranged in the X-axis direction. Beams projected from the light sources 117A and 117B enter the light guide plate 81 from the end surfaces thereof; are projected from the light guide plate 81 after transmitting therethrough; pass through a downward prism sheet 82 and the light distribution control member 83 in this order; and enter the liquid crystal display panel 106. Image light is generated by the liquid crystal display panel 106 spatially modulating the beams that enter from the rear surface 106a, and is projected from the display surface 106b. The projected light is recognized as an image.

The light guide plate 81 is a plate-like member made of a transparent optical material such as an acrylic resin (PMMA), and its rear surface (surface opposite to liquid crystal display panel 106 side) has a configuration in which microscopic optical elements 81a, which protrude to the opposite direction of the liquid crystal display panel 106 side, are regularly-arranged along a surface parallel to the display surface 106b. The shape of microscopic optical element 81a forms a part of a spherical shape, and the surface thereof has a constant curvature. The microscopic elements 81a having the spherical shape are provided in a two-dimensional manner along the X-Y plane.

As a working example of the microscopic optical element 81a, a microscopic optical element may be employed having, for example, a surface curvature of about 0.15 mm, a maximum height of about 0.005 mm, and a refractive index of about 1.49. The distance between the centers of microscopic optical elements may be 0.077 mm. Note that, while the acrylic resin can be employed as a material for the light guide plate 81, the material is not limited thereto. Another resin material such as a polycarbonate resin or a glass material may be used in place of the acrylic resin, as long as the material has high light transmittance and high molding processability.

As described above, the beams projected from the light sources 117A and 117B enter the light guide plate 81 from the lateral end surfaces thereof. While transmitting through the light guide plate 81, the incident beams are reflected totally, due to the refractive index difference between the microscopic optical element 81a of the light guide plate 81 and the airspace, and are projected from a front surface of the light guide plate 81 in the direction of the liquid crystal display panel 106. In order to equalize a planar brightness distribution of the emission beams projected from the front surface of the light guide plate 81, the microscopic optical elements 81a are more densely provided as getting away from the lateral end surface, while more sparsely provided as coming close to the lateral end surface. Note that, not limited to this, the microscopic optical elements 81a may be provided more uniformly on the surface so that a desired planar brightness distribution will be obtained.

The light reflection sheet 80 is provided so that beams projected from the rear surface of the light guide plate 81 will be reflected and reutilized as illumination beams to be emitted onto the rear surface 106a of the liquid crystal display panel 106, and, for example, a light reflection sheet whose base material is a resin such as polyethylene terephthalate or a light reflection sheet in which a metal is vapor-deposited onto a substrate surface may be used.

The downward prism sheet 82 is a transparent optical sheet, and its rear surface has a configuration in which microscopic optical elements 82a, which protrude to the opposite direction of the liquid crystal display panel 106 side, are regularly-arranged along a plane parallel to the display surface 106b. The shape of microscopic optical element 82a forms a triangular prism that has a constant vertex angle. As shown in FIG. 2, the microscopic optical element 82a is a triangular prism having its ridgeline in the X-axis direction, and a number of such elements are regularly-arranged in the Y-axis direction along the X-Y plane. The pitch of the microscopic optical elements 82a is constant, but the pitch may be variable. Each of the microscopic optical elements 82a has two slanted planes.

As a working example of the microscopic optical element 82a, a microscopic optical element may be employed, for example, having a vertex angle, formed by two slanted planes, of 68 degrees, a height of 0.022 mm, and a refractive index of 1.49. The microscopic optical elements 82a may be arranged to have a pitch of 0.03 mm in the Y-axis direction. Note that, while PMMA can be employed as a material for the downward prism sheet 82, the material is not limited thereto. Another resin material such as a polycarbonate resin or a glass material may be used, as long as the material has high light transmittance and high molding processability.

The light distribution control member 83 is a transparent and plate-like or sheet-like member, and includes an incident surface 83a in which beams projected from the optical member 107 enter and an emission surface 83b from which the beams that enter from the incident surface 83a are emitted. Plural concaves 109 are provided, each extending in the X-axis direction, on the emission surface 83b of the light distribution control member 83. The concaves 109 are regularly-arranged in the Y-axis direction along the plane parallel to the display surface 106b. The respective concaves 109 are formed so that their curvature radiuses decrease in the order of a central portion 110A, an intermediate portion 110B, and a peripheral portion 110C. It is desirable that the width of the concave 109 in the Y-direction is almost equal to or less than the width of a pixel (not shown here) of the liquid crystal display panel 106, and, further, it is desirable to be no more than the width of a picture element that will be described later.

The beams projected from the light sources 117A and 117B enter the light guide plate 81 from the incident end surfaces thereof and transmit through the light guide plate 81 while being reflected totally. During the transmission, a part of the transmitted beams are reflected by the microscopic optical element 81a located at the rear surface of the light guide plate 81, and are projected from the front surface (emission surface) of the light guide plate 81 as the illumination beams. The beams transmitting through the light guide plate 81 are transformed by the microscopic optical element 81a into beams that have a light distribution centered in the direction slanted by a predetermined angle from the Z-axis direction, and the transformed beams are projected from the front surface. The beams projected from the light guide plate 81 with the predetermined angle enter the microscopic optical element 82a of the downward prism sheet 82, are totally reflected internally by the slanted plane of the microscopic optical element 82a, and then are projected from the front surface (emission surface) with high directivity in the normal direction of the emission surface. That is, owing to a function of the optical member 107 configured with the light guide plate 81 and the downward prism sheet 82, the beams projected from the light sources 117A and 117 are transformed into beams having a narrow-angle light distribution and the transformed beams are projected from the optical member 107 in the direction of the liquid crystal display panel 106.

The beam having the narrow-angle light distribution is a beam with high directivity in which rays having intensity of no less than a predetermined value are localized within a predetermined angle range centered in the Z-axis direction which is the normal direction of the display surface 106b of the liquid crystal display panel 106.

The beams projected from the downward prism sheet 82 enter the incident surface 83a of the light distribution control member 83, and then are projected, with their light distribution being controlled as will be described later, by the plural concaves 109 provided on the emission surface 83b. The beams projected from the light distribution control member 83 are utilized as illumination beams to be emitted onto the rear surface 106a of the liquid crystal display panel 106.

Before explaining a function of the light distribution control member 83 in the liquid crystal display device in Embodiment 1, a relationship will be described between a viewing distance and a planar brightness distribution in a conventional liquid crystal display device which serves as a comparative example.

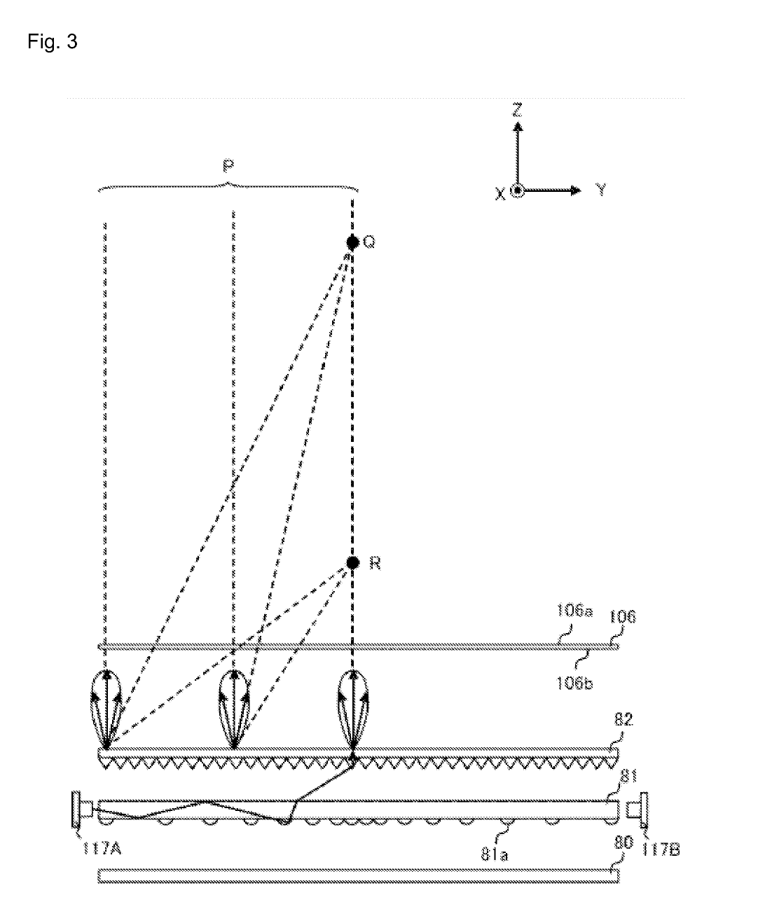

FIG. 3 is a diagram schematically showing a configuration of a liquid crystal display device in Comparative Example 1. The liquid crystal display device in Comparative Example 1 is the same, except that no light distribution control member 83 is provided, with the liquid crystal display device in Embodiment 1, and projects beams having a narrow-angle light distribution as described above. In FIG. 3, “P” denotes a viewpoint when the viewing distance is infinite. “R” and “Q” are viewpoints located on the normal line that passes through a center portion of a display surface of a liquid crystal display panel. “R” denotes a viewpoint when the viewing distance is short, and “Q” denotes a viewpoint different from “R” and is located between “P” and “R”. Since the beams projected from the downward prism sheet 82 have high directivity in the Z-axis direction, a planar brightness distribution is observed to be uniform when viewed from the viewpoint “P”.

Meanwhile, when viewed from the viewpoint “Q”, while brightness at the central portion is similar to that when viewed from the viewpoint “P”, brightness of the beam projected from the peripheral portion is observed to be decreasing as coming close to the peripheral portion. Furthermore, when viewed from the viewpoint “R”, while brightness at the central portion is not different from that when viewed from “P” and “Q”, brightness of the beam projected from the peripheral portion is observed to be decreasing as coming close to the peripheral portion. When viewed from “R”, brightness at the peripheral portion greatly decreases compared to that when viewed from “Q”. That is, in the liquid crystal display device in Comparative Example 1, a decrease in brightness at the peripheral portion becomes prominent as the viewing distance decreases.

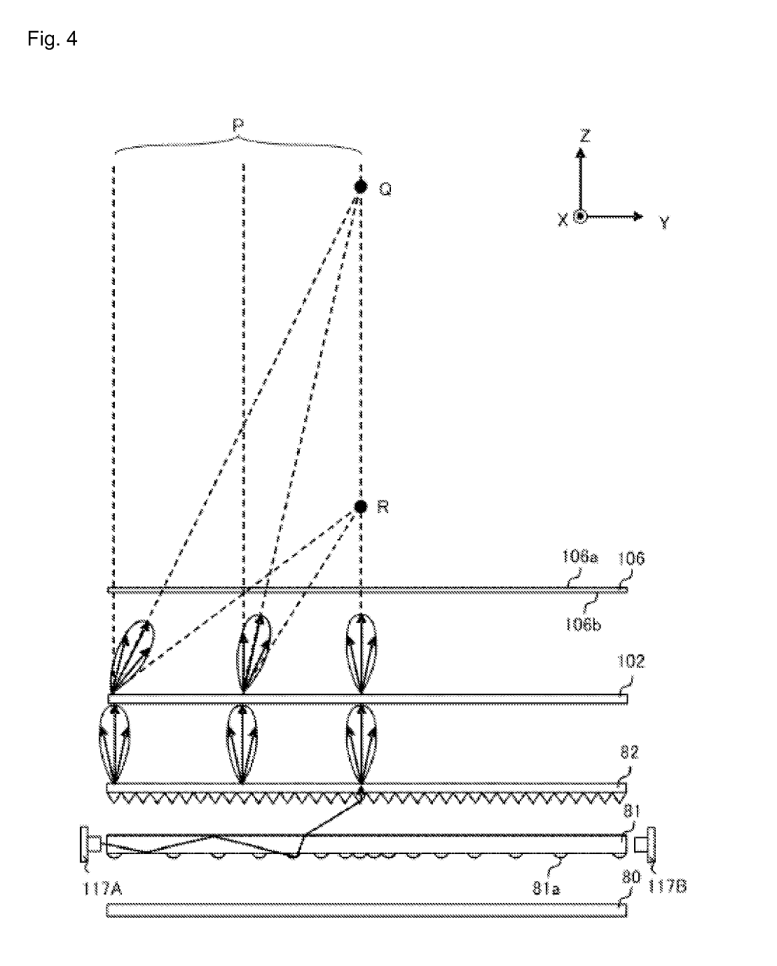

FIG. 4 is a diagram schematically showing a configuration of a liquid crystal display device in Comparative Example 2. In the liquid crystal display device in Comparative Example 2, a Fresnel lens sheet 102 is further provided in front of the downward prism sheet 82 in the liquid crystal display device in Comparative Example 1, and the configuration other than that is the same. In the liquid crystal display device in Comparative Example 2, as a means for alleviating the decrease in peripheral brightness in the liquid crystal display device in Comparative Example 1 shown in FIG. 3, directivity at the peripheral portion is slanted toward the viewpoint “Q” using the Fresnel lens sheet 102.

In this configuration, brightness is observed to be uniform at the central portion and the peripheral portion when viewed from the viewpoint “Q”. However, brightness at the peripheral portion decreases when viewed from both viewpoints “P” and “R”. Thus, in the method using the Fresnel lens sheet 102, a viewpoint in which planar brightness is observed to be uniform is merely changed from the conventional infinite point to a point having a finite distance. Therefore, since the method does not fundamentally fix the problem of decreasing the planar brightness, the decrease in peripheral brightness similar to the conventional case arises when getting away from the finite distance viewpoint.

The light distribution control member 83 in the liquid crystal display device in Embodiment 1 is a member for alleviating the decrease in peripheral brightness associated with the change of viewing distance described above.

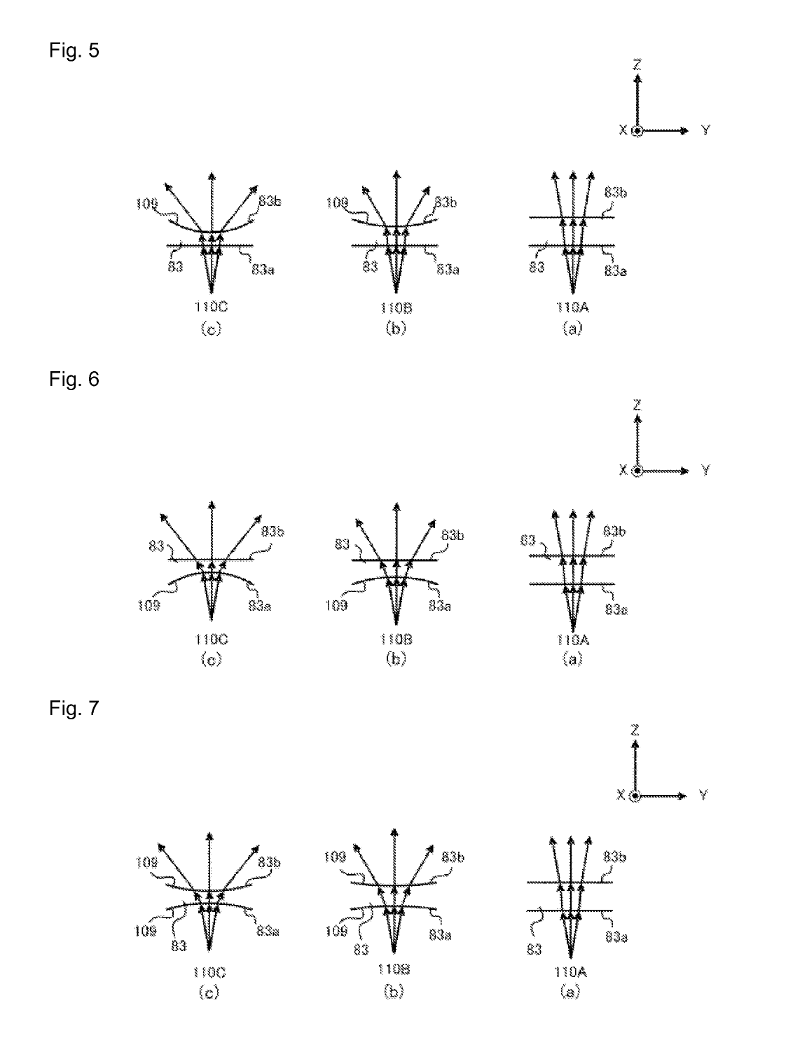

FIG. 5 is a cross-sectional view enlargedly showing a part of the light distribution control member 83, and (a) through (c) in FIG. 5 show cross-sectional shapes at the central portion 110A, intermediate portion 110B, and peripheral portion 110C of the light distribution control member 83 in FIG. 1, respectively. While the emission surface 83b of the central portion 110A in (a) in FIG. 5 has a planar shape, the concaves 109 are formed on the emission surface 83b of the intermediate portion 110B in (b) in FIG. 5 and the peripheral portion 110C in (c) in FIG. 5. As described above, the curvature radius of the concave 109 at the peripheral portion 110C in (c) in FIG. 5 is smaller than that at the intermediate portion 110B in (b) in FIG. 5. Note that, while radiuses are shown here only at three areas, i.e. central, intermediate, and peripheral portions 110A, 110B, and 110C, the curvature radiuses of the concaves 109 are formed, including the other areas, to be decreasing as coming close to the peripheral portion 110C.

Since the emission surface 83b of the light distribution control member 83 has the planar shape at the central portion 110A, the beam that is projected from the downward prism sheet 82 and that has the narrow-angle light distribution is projected from the light distribution control member 83 without changing its light distribution. At the intermediate portion 110B, since the concave 109 having a certain curvature radius is provided on the emission surface 83b, the beam that is projected from the downward prism sheet 82 and that has the narrow-angle light distribution is projected from the light distribution control member 83 with its light distribution broadened. At the peripheral portion 110C, since the concave 109 having a smaller curvature radius is provided, the beam that is projected from the downward prism sheet 82 and that has the narrow-angle light distribution is projected from the light distribution control member 83 with its light distribution more broadened.

As a result, as for the beams projected from the light distribution control member 83 shown in FIG. 1, the beams that are projected from the optical member 107 and that have the narrow-angle light distribution are transformed into beams whose light distributions are gradually broadened as moving on from the central portion toward the peripheral portion of the liquid crystal display panel 106, and the transformed beams are projected from the light distribution control member 83. That is, the percentage of an emission beam component having a slant angle from the Z-axis gradually increases as moving on from the central portion toward the peripheral portion of the liquid crystal display panel 106. In this case, at the infinite viewpoint “P”, a beam 84a projected from the central portion 110A, a beam 85c projected from the intermediate portion 110B, and a beam 86c projected from the peripheral portion 110C are observed. At the middle-distance viewpoint “Q”, the beam 84a projected from the central portion 110A, a beam 85a projected from the intermediate portion 110B, and a beam 86a projected from the peripheral portion 110C are observed. At the short-distance viewpoint “R”, the beam 84a projected from the central portion 110A, a beam 85b projected from the intermediate portion 110B, and a beam 86b projected from the peripheral portion 110C are observed. Therefore, since the beams that are projected from the optical member 107 and that have the narrow-angle light distribution are transformed so as to have the broadened light distribution using the light distribution control member 83, the decrease in brightness at the peripheral portion can be alleviated when observed from any viewpoint located between the infinite distance and the short distance.

In the liquid crystal display device in Embodiment 1, the light distribution control member 83 is provided, for receiving the beams that are projected from the optical member 107 and that have the narrow-angle light distribution and for projecting the beams in the direction of the liquid crystal display panel 106; the plural concaves 109 are provided on the light distribution control member 83; and the curvature radiuses of the plural concaves 109 are formed to be decreasing as coming close to the peripheral portion 110C of the light distribution control member 83. Therefore, since the beams that have the narrow-angle light distribution are transformed into beams whose light distributions are gradually broadened as moving on from the central portion toward the peripheral portion of the liquid crystal display panel 106, the decrease in brightness at the peripheral portion can be alleviated when observed from any viewpoint located between the infinite distance and the short distance.

As will be described later, plural convexes in place of the plural concaves 109 may be provided on the emission surface 83b of the light distribution control member 83. In that case, however, since the beams projected from the optical member 107 are necessary to be once condensed and then again diverged, a convex having power of large absolute value compared to that of the concave 109 is needed in order to broaden the beams having the narrow-angle light distribution. Therefore, when there is an error in a curved surface shape of the convex, the error in the shape greatly affects the light distribution of the beams projected from the emission surface 83b of the light distribution control member 83. On the other hand, in Embodiment 1, since the plural concaves 109 are provided on the emission surface 83b of the light distribution control member 83, the beams having the narrow-angle light distribution can be broadened with comparatively low power. Therefore, even if there is an error in the spherical shape of the concave 109, the error in the shape less affects the light distribution of the beams projected from the emission surface 83b of the light distribution control member 83. That is, sensitivity against the error in shape can be reduced when fabricating the concave 109.

The optical member 107 is configured with the light guide plate 81 for internally reflecting the beams projected from the light sources 117A and 117B at the rear surface located at the opposite direction of the liquid crystal display panel 106 side and for projecting the reflected beams in the direction of the liquid crystal display panel 106, and with the downward prism sheet 82 for transforming the beams projected from the light guide plate 81 in the direction of the liquid crystal display panel 106 into the beams having the narrow-angle light distribution. Therefore, a backlight with less decrease in brightness at the peripheral portion can be fabricated easily by only providing the light distribution control member 83, which is designed to be applicable to various purposes, over the downward prism sheet 82 that has been widely used conventionally.

Note that, while a configuration is shown in Embodiment 1 in which the plural concaves 109 are provided on the emission surface 83b of the light distribution control member 83, the position for providing the concaves 109 is not limited thereto. FIG. 6 shows a variant of the liquid crystal display device in Embodiment 1, and is a cross-sectional view showing a part of the light distribution control member 83. In this variant, plural concaves 109 are provided on the incident surface 83a of the light distribution control member 83. The effect similar to the above-described one can be obtained in this configuration.

In addition, plural concaves 109 may be provided on both surfaces of the light distribution control member 83. FIG. 7 shows another variant of the liquid crystal display device in Embodiment 1, and is a cross-sectional view showing a part of the light distribution control member 83. In this variant, plural concaves 109 are provided on both the incident surface 83a and the emission surface 83b of the light distribution control member 83. The effect similar to the above-described one can be obtained in this configuration.

Note that, while the incident surface 83a of the light distribution control member 83 has the planar shape in the backlight in Embodiment 1, an arbitrary curved surface may be employed so that a desired light distribution will be obtained.

### Embodiment 2

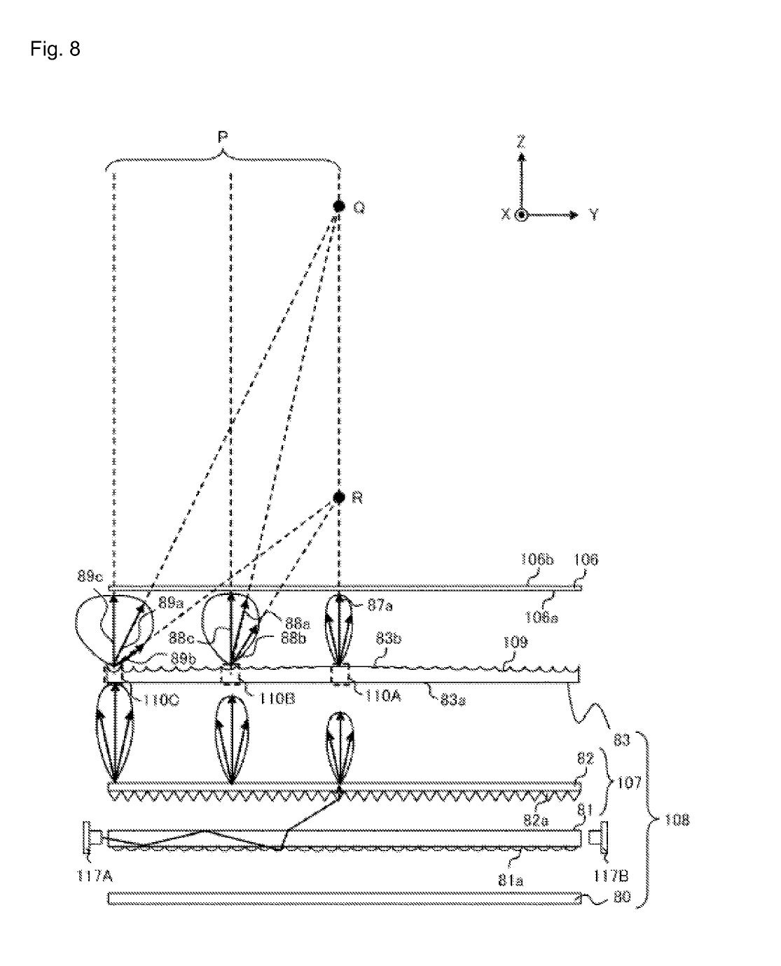

FIG. 8 is a schematic diagram showing a configuration of a liquid crystal display device in Embodiment 2. In the liquid crystal display device in Embodiment 2, the microscopic optical elements 81a at the rear surface of the light guide plate 81 configuring the optical member 107 are formed so as to be more densely distributed at the peripheral portion than the configuration in Embodiment 1 when the number of elements per unit area is compared. Because the configuration of the liquid crystal display device in Embodiment 2 is similar to that in Embodiment 1, except that the distribution of the microscopic optical elements 81a differs, the explanation thereof will be skipped.

In a light guide plate of a conventional backlight, it is common that the microscopic optical elements provided at the rear surface of the light guide plate are more sparsely provided as coming close to the light source, while more densely provided as coming close to the central portion so that the planar brightness of the backlight will be equalized. The reason is that, if the microscopic optical elements are densely provided at the portion close to the light source, the amount of beams projected from the light guide plate increases at the peripheral portion and decreases at the central portion, thereby reducing brightness at the central portion.

Meanwhile, in the backlight in Embodiment 2, the microscopic optical elements 81a are more densely provided at the portion close to the light sources 117A and 117B compared to the above-described arrangement in which the planar brightness distribution is equalized. As a result, as shown in FIG. 8, brightness in the normal direction of the beams projected from the downward prism sheet 102 at the peripheral portion is larger than that at the central portion. Thus, when compared to Embodiment 1, while the beams projected from the light distribution control member 83 have the same light distribution, the intensity of the projected beam at each emission angle increases as coming close to the peripheral portion of the light distribution control member 83.

In this case, at the viewpoint “P”, a beam 87a projected from the central portion 110A, a beam 88c projected from the intermediate portion 110B, and a beam 89c projected from the peripheral portion 110C are observed. At the viewpoint “Q”, the beam 87a projected from the central portion 110A, a beam 88a projected from the intermediate portion 110B, and a beam 89a projected from the peripheral portion 110C are observed. At the viewpoint “R”, the beam 87a projected from the central portion 110A, a beam 88b projected from the intermediate portion 110B, and a beam 89b projected from the peripheral portion 110C are observed. Here, the intensity of the beam 89b, to be observed at “R”, projected from the peripheral portion 110C is larger than that of the corresponding beam 86b projected from the peripheral portion 110C in Embodiment 1.

In the backlight in Embodiment 2, since the microscopic optical elements 81a at the light guide plate 81 are provided so as to be more densely provided at the peripheral portion than the configuration in Embodiment 1 when the number of elements per unit area is compared, the intensity of the beam at the peripheral portion in the direction having a large angle against the normal direction of the liquid crystal display panel 106 can be increased. Therefore, the decrease in brightness at the peripheral portion can be more alleviated in addition to the effect in Embodiment 1.

### Embodiment 3

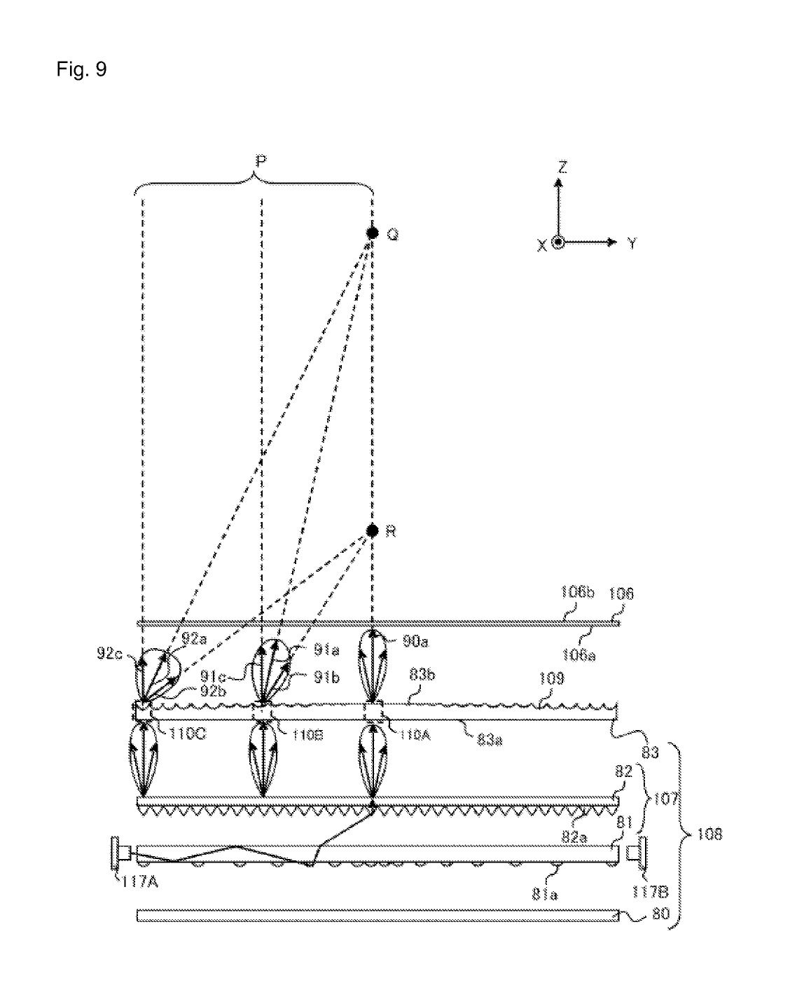

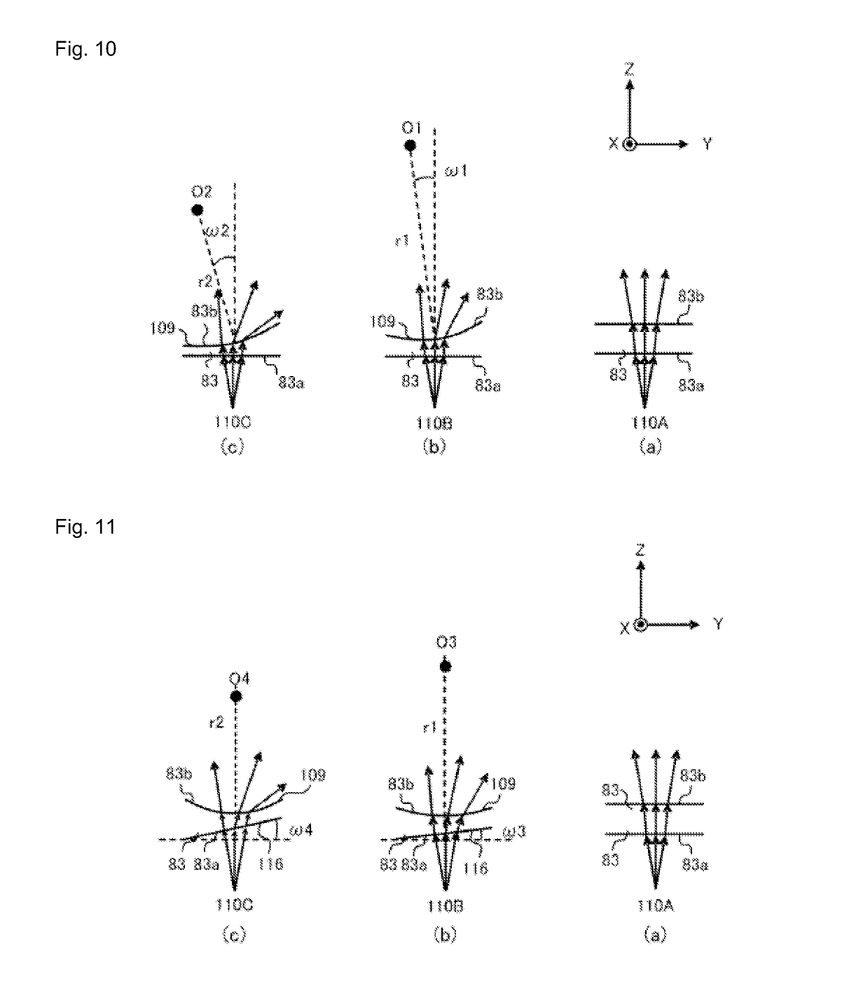

FIGS. 9 and 10 show a liquid crystal display device in Embodiment 3. FIG. 9 is a diagram schematically showing a configuration of the liquid crystal display device, and (a) through (c) in FIG. 10 are cross-sectional views enlargedly showing the central, intermediate, and peripheral portions of a light distribution control member in FIG. 9, respectively.

As shown in FIG. 9, the liquid crystal display device in Embodiment 3 has a configuration in which plural concaves 109 are provided on the light distribution control member 83, similar to that in Embodiment 1. However, while the direction of the peak component of the beams projected from the light distribution control member 83 is parallel to the normal direction of the liquid crystal display panel 106 in Embodiment 1, the difference in Embodiment 3 is that the concaves 109 are slanted against the normal direction of the display surface so that the direction of the peak component of the beams projected from the light distribution control member 83 will be directed to the normal line passing through the central portion of the display surface of the liquid crystal display panel. Since the other configuration is similar to that in Embodiment 1, the explanation thereof will be skipped.

While the emission surface 83b of the central portion 110A in (a) in FIG. 10 is a planar shape, the concaves 109 are formed on the emission surfaces 83b of the intermediate portion 110B in (b) in FIG. 10 and the peripheral portion 110C in (c) in FIG. 10. The concave 109 at the intermediate portion 110B has a curvature radius of r1, and is slanted by ω1 against the Z-axis, which is the normal direction of the display surface 106b, in the direction of the peripheral portion of the light distribution control member 83. That is, a straight line connecting the center point of the concave 109 and the curvature center O1 thereof forms the angle ω1 against the Z-axis. The concave 109 at the peripheral portion 110C has a curvature radius of r2, and is slanted by ω2 against the Z-axis in the direction of the peripheral portion of the light distribution control member 83. That is, a straight line connecting the center point of the concave 109 and the curvature center O2 thereof forms the angle ω2 against the Z-axis. The curvature radius r2 is smaller than r1, and the slant angle ω2 in the concave 109 is larger than ω1. While configurations are shown here only at three areas, i.e. central, intermediate, and peripheral portions 110A, 110B, and 110C, the curvature radius of the concave 109 decreases as coming close to the peripheral portion 110C, and the slant angle of the concave 109 increases as coming close to the peripheral portion 110C.

Since the emission surface 83b of the light distribution control member 83 is a planar shape at the central portion 110A, a beam that is projected from the downward prism sheet 82 and that has a narrow-angle light distribution is projected from the light distribution control member 83 without changing its light distribution. Because the concave 109 having the curvature radius of r1 is provided on the emission surface 83b at the intermediate portion 110B and the concave 109 is slanted by ω1 against the Z-axis in the direction of the peripheral portion of the light distribution control member 83, a distribution of a beam that is projected from the downward prism sheet 82 and that has the narrow-angle light distribution is broadened in the Y-axis direction and the direction of the peak component of the beam is slanted to be directed to the normal line passing through the central portion of the display surface 106b of the liquid crystal display panel 106, thereby being slanted as a whole in the direction of the central portion.

Since the concave 109 having the curvature radius of r2, which is smaller than the above-described curvature radius of r1, is provided at the peripheral portion 110C and the concave 109 is slanted by ω2, which is larger than ω1, against the Z-axis in the direction of the peripheral portion of the light distribution control member 83, a distribution of a beam that is projected from the downward prism sheet 82 and that has the narrow-angle light distribution is more broadened in the Y-axis direction compared to the above-described case in the intermediate portion 110B, and also the direction of the peak component of the beam is more slanted to be directed to the normal line passing through the central portion of the display surface 106b of the liquid crystal display panel 106 compared to the above-described case in the intermediate portion 110B.

As a result, as shown in FIG. 9, the beams that are projected from the optical member 107 and that have the narrow-angle light distribution are projected from the light distribution control member 83 so that the light distributions thereof are gradually broadened as moving on from the central portion toward the peripheral portion of the liquid crystal display panel 106; the direction of the peak component of the beam is slanted to be directed to the central portion of the display surface 106b of the liquid crystal display panel 106; and the projected beam has an increased component projected in the direction of the normal line passing through the central portion of the display surface 106b of the liquid crystal display panel 106 as moving on to the peripheral portion 110C of the light distribution control member 83.

In this case, at the viewpoint “P”, a beam 90a projected from the central portion 110A, a beam 91c projected from the intermediate portion 110B, and a beam 92c projected from the peripheral portion 110C are observed. At the viewpoint “Q”, the beam 90a projected from the central portion 110A, a beam 91a projected from the intermediate portion 110B, and a beam 92a projected from the peripheral portion 110C are observed. At the viewpoint “R”, the beam 90a projected from the central portion 110A, a beam 91b projected from the intermediate portion 110B, and a beam 92b projected from the peripheral portion 110C are observed. Now, the beams 90a, 91a, and 92a are peak components projected from the light distribution control member 83. Here, the intensity of the beam 92b, which is observed at “R”, projected from the peripheral portion 110C is larger than that of the corresponding beam 86b projected from the peripheral portion 110C in Embodiment 1. Therefore, since the beams that are projected from the optical member 107 and that have the narrow-angle light distribution are transformed so as to have the broadened light distribution using the light distribution control member 83, and the beams are also transformed so that the direction of the peak component thereof is slanted to be directed to the normal line passing through the central portion of the display surface 106b of the liquid crystal display panel 106, the decrease in brightness at the peripheral portion can be alleviated when observed from any viewpoint located between the infinite distance and the short distance.

In the backlight in Embodiment 3, since the concave 109 is slanted against the normal direction of the display surface 106b so that the direction of the peak component of the beams projected from the light distribution control member 83 will be slanted to be directed to the normal line passing through the central portion of the display surface 106b of the liquid crystal display panel 106, the decrease in brightness at the peripheral portion can be more alleviated in addition to the effect in Embodiment 1.

In addition, because the slant angle of the concave 109 increases as coming close to the peripheral portion 110C of the light distribution control member 83, uniformity of the planar brightness distribution of the backlight can be improved.

Note that, while the concaves 109 are provided on the emission surface 83b of the light distribution control member 83 in Embodiment 3, the concaves 109 may be provided on the incident surface 83a and the concaves 109 may be slanted so that the direction of the peak component of the beams projected from the light distribution control member 83 will be directed to the normal line passing through the central portion of the display surface 106b of the liquid crystal display panel 106. In addition, the concaves 109 may be provided on both the incident surface 83a and the emission surface 83b and the concaves 109 may be slanted so that the direction of the peak component of the beams projected from the light distribution control member 83 will be directed to the normal line passing through the central portion of the display surface 106b of the liquid crystal display panel 106. The effect similar to the above-described one can be obtained in these configurations.

### Embodiment 4

FIG. 11 is a diagram showing a liquid crystal display device in Embodiment 4, and (a) through (c) in FIG. 11 are cross-sectional views enlargedly showing central, intermediate, and peripheral portions of a light distribution control member, respectively. In Embodiment 3, a configuration is shown in which the concaves 109 are slanted against the normal line of the display surface 106b so that the peak component of the beams projected from the light distribution control member 83 will be slanted to be directed to the normal line passing through the central portion of the display surface 106b of the liquid crystal display panel 106. On the other hand, the concaves 109 may be provided on the emission surface 83b and at the same time, slanted planes 116 opposite to the concaves 109 may be provided on the incident surface 83a. Also in this configuration, the direction of the peak component of the beams projected from the light distribution control member 83 can be directed to the central portion of the display surface 106b of the liquid crystal display panel 106. Since the configuration, except the shape of the light distribution control member 83, is similar to that in Embodiment 3, the explanation thereof will be skipped.

While the incident surface 83a and emission surface 83b of the central portion 110A in (a) in FIG. 11 are planar shapes, the concaves 109 are formed on the emission surface 83b and, at the same time, the slanted planes 116 opposite to the concaves 109 are formed on the incident surface 83a at the intermediate portion 110B in (b) in FIG. 11 and the peripheral portion 110C in (c) in FIG. 11. The concave 109 having a curvature radius of r1 is formed on the emission surface 83b at the intermediate portion 110B, and a straight line connecting the center point of the concave 109 and the curvature center O3 thereof is parallel to the Z-axis. The slanted plane 116 opposite to the concave 109 is formed on the incident surface 83a, and the slanted plane 116 is slanted by ω3 against the X-axis and Y-axis, which are in parallel direction to the liquid crystal display panel 106, in the direction of the peripheral portion of the light distribution control member 83.

The concave 109 having a curvature radius of r2 is formed on the emission surface 83b at the peripheral portion 110C, and a straight line connecting the center point of the concave 109 and the curvature center O4 thereof is parallel to the Z-axis. The slanted plane 116 opposite to the concave 109 is formed on the incident surface 83a, and the slanted plane 116 is slanted by ω4 against the X-axis and Y-axis, which are in parallel direction to the liquid crystal display panel 106, in the direction of the peripheral portion of the light distribution control member 83. The curvature radius r2 is smaller than r1, and the slant angle ω4 is larger than ω3. While configurations are shown here only at three areas, i.e. central, intermediate, and peripheral portions 110A, 110B, and 110C, the curvature radius of the concave 109 is formed to be decreasing as coming close to the peripheral portion 110C, and the slant angle of the slanted plane 116 is formed to be increasing as coming close to the peripheral portion 110C, including the other areas.

Since the incident surface 83a and emission surface 83b of the light distribution control member 83 are planar shapes at the central portion 110A, a beam that is projected from the downward prism sheet 82 and that has a narrow-angle light distribution is projected from the light distribution control member 83 without changing its light distribution. Because the concave 109 having the curvature radius of r1 is provided on the emission surface 83b and the slanted plane 116 slanted by ω3 against the X-axis and Y-axis is formed on the incident surface 83a at the intermediate portion 110B, the direction of the peak component of a beam that is projected from the downward prism sheet 82 and that has the narrow-angle light distribution is directed to the normal line passing through the central portion of the display surface 106b of the liquid crystal display panel 106 by the slanted plane 116 of the incident surface 83a, and a distribution of the beam is broadened in the Y-axis direction by the concave 109 of the emission surface 83b.

Since the concave 109 having the curvature radius of r2, which is smaller than the above-described curvature radius of r1, is provided on the emission surface 83b and the slanted plane 116 slanted by ω4, which is larger than the above-described slant angle ω3, against the X-axis and Y-axis is formed on the incident surface 83a at the peripheral portion 110C, a beam that is projected from the downward prism sheet 82 and that has the narrow-angle light distribution is more slanted compared to the above-described case in the intermediate portion 110B by the slanted plane 116 on the incident surface 83a, and a distribution of the beam is more broadened in the Y-axis direction compared to the above-described case in the intermediate portion 110B by the concave 109 of the emission surface 83b. As a result, the beams that are projected from the optical member 107 and that have the narrow-angle light distribution are transformed so that the light distributions thereof are gradually broadened as moving on from the central portion toward the peripheral portion of the liquid crystal display panel 106 and that the direction of the peak component thereof is directed to the normal line passing through the central portion of the display surface 106b of the liquid crystal display panel 106, and the transformed beams are projected from the light distribution control member 83. Therefore, the decrease in brightness at the peripheral portion can be alleviated when observed from any viewpoint located between the infinite distance and the short distance.

In the backlight in Embodiment 4, since the plural concaves 109 are provided on the emission surface 83b and, at the same time, the plural slanted planes 116 opposite to the plural concaves 109 are provided on the incident surface 83a of the light distribution control member 83, and the slanted planes 116 are formed so that the direction of the peak component of the beams projected from the light distribution control member 83 will be directed to the normal line passing through the central portion of the display surface 116b of the liquid crystal display panel 116, the effect similar to that in Embodiment 3 can be obtained.

Note that, while a configuration is shown here in which the plural slanted planes 116 are provided on the incident surface 83a and the plural concaves 109 are provided on the emission surface 83b, the similar effect can be obtained when the plural concaves 109 are provided on the incident surface 83a and the plural slanted planes 116 are provided on the emission surface 83b.

### Embodiment 5

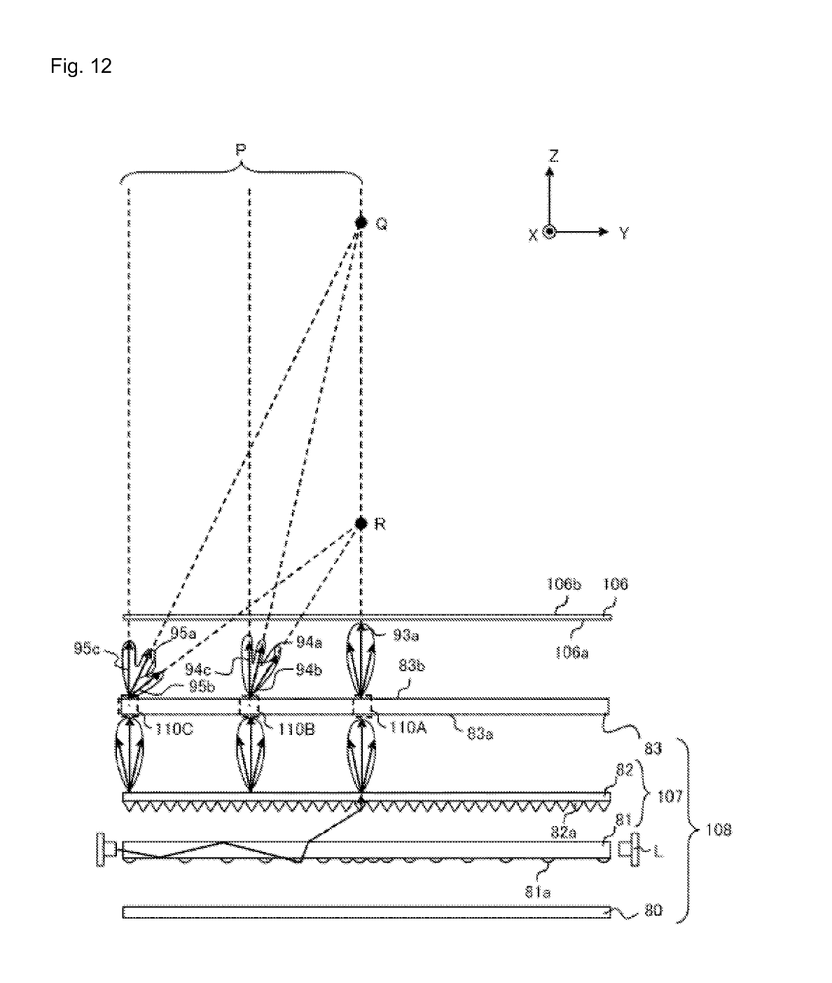

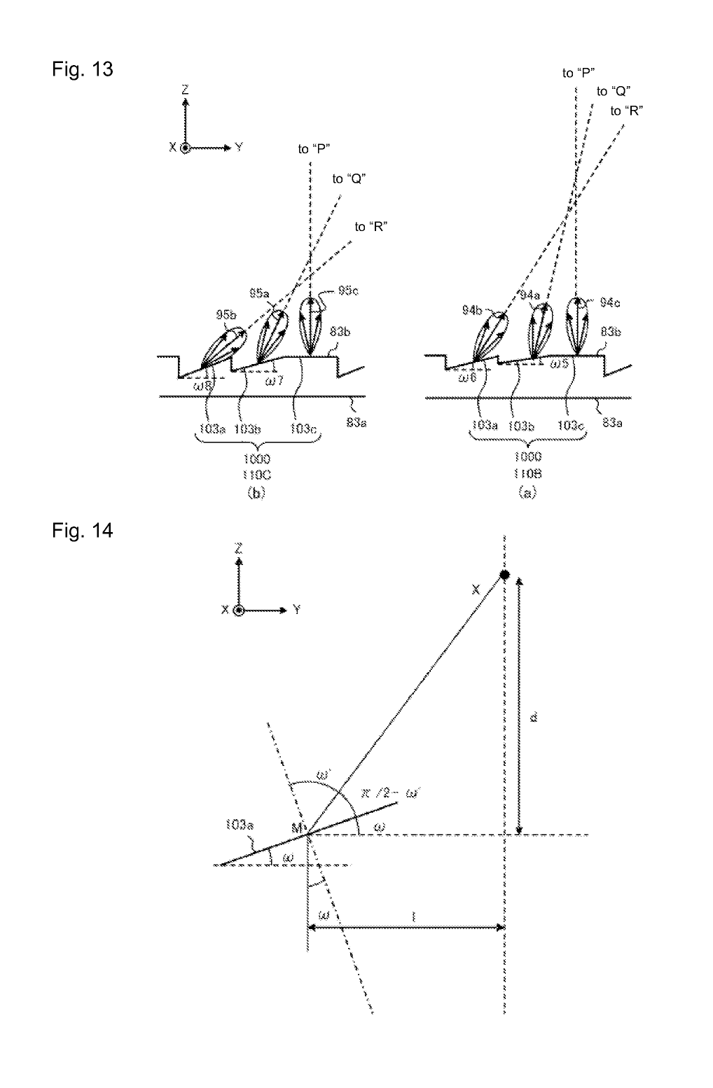

FIGS. 12 through 14 show a liquid crystal display device in Embodiment 5. FIG. 12 is a diagram schematically showing a configuration of the liquid crystal display device; (a) and (b) in FIG. 13 are cross-sectional views enlargedly showing intermediate and peripheral portions of a light distribution control member, respectively; and FIG. 14 is an explanatory diagram for calculating an angle formed between an X-Y plane and each of optical surfaces.

As shown in FIG. 12, the liquid crystal display device in Embodiment 5 has a configuration in which the liquid crystal display panel 106, light distribution control member 83, downward prism sheet 82, light guide plate 81, light reflection sheet 80, and light sources 117A and 117B are provided, similar to that in Embodiment 1. However, while the plural concaves 109 are provided on the light distribution control member 83 in Embodiment 1, plural optical surfaces 1000 are provided on the light distribution control member 83 in Embodiment 5 so that the direction of the peak component of a beam having a narrow-angle light distribution will be transformed to be directed to plural viewing points. Since the configuration, except the light distribution control member 83, is similar to that in Embodiment 1, the explanation thereof will be skipped.

As shown in (a) and (b) in FIG. 13, the optical surface 1000 includes a first surface 103a, a second surface 103b, and a third surface 103c. These are planar surfaces slanted against the X-axis and Y-axis with mutually different angles, and the first surface 103a directs the direction of the peak component of the beam that enters the light distribution control member 83 and that has the narrow-angle light distribution to the short-distance viewpoint “R”; the second surface 103b directs to the middle-distance viewpoint “Q”; and the third surface 103c directs to the infinite viewpoint “P”.

As shown in (a) in FIG. 13, in the optical surface 1000 at the intermediate portion 110B, angles formed between the first surface 103a/second surface 103b and the Y-axis are ω6/ω5, respectively, and the third surface 103c is parallel to the Y-axis. Here, ω6 is larger than ω5. As shown in (b) in FIG. 13, in the optical surface 1000 at the peripheral portion 110C, angles formed between the first surface 103a/second surface 103b and the Y-axis are ω8/ω7, respectively, and the third surface 103c is parallel to the Y-axis. Here, ω8 is larger than ω7. Note that, while angles are shown here only at two areas, i.e. intermediate and peripheral portions 110B and 110C, the slant angles of the first and second surfaces 103a and 103b are formed, including the other areas, to be increasing as coming close to the peripheral portion 110C.

As for a beam that has been projected from the downward prism sheet 82 and is projected from the light distribution control member 83 via the third surface 103c, the directions of beams 94c and 95c, which are the peak components of the beam having a narrow-angle light distribution, coincide with the direction of the viewpoint “P.”

Meanwhile, as for a beam projected from the light distribution control member 103 via the second surface 103b, the directions of beams 94a and 95a, which are the peak components of the beam having the narrow-angle light distribution, are changed corresponding to the slants of the second surface 103b, i.e. ω5 and ω7, respectively, and coincide with the direction of the viewpoint “Q”. Also, as for a beam projected from the light distribution control member 103 via the first surface 103a, the directions of beams 94b and 95b, which are the peak components of the beam having the narrow-angle light distribution, are changed corresponding to the slants of the first surface 103a, i.e. ω6 and ω8, respectively, and coincide with the direction of the viewpoint “R”.

As a result, as shown in FIG. 12, a beam 93a projected from the central portion 110A, the beam 94c projected from the intermediate portion 110B, and the beam 95c projected from the peripheral portion 110C are observed at the viewpoint “P”. The beam 93a projected from the central portion 110A, the beam 94a projected from the intermediate portion 110B, and the beam 95a projected from the peripheral portion 110C are observed at the viewpoint “Q”. The beam 93a projected from the central portion 110A, the beam 94b projected from the intermediate portion 110B, and the beam 95b projected from the peripheral portion 110C are observed at the viewpoint “R”. Thus, since the beams that are projected from the optical member 107 and that have the narrow-angle light distribution are transformed so that the direction of the peak component thereof is directed to each of the directions of the viewpoints “P”, “Q”, and “R”, certain brightness at the peripheral portion can be ensured at all the viewpoints “P”, “Q”, and “R”.

Note that, while explanations on the central, intermediate, and peripheral portions 110A, 110B, and 110C are made in the above, optical surfaces provided at areas other than the three portions are formed so that the peak components of the beams projected from the third, second, and first surfaces 103c, 103b, and 103a will be observed at the viewpoints “P”, “Q”, and “R”, respectively.

Next, how to calculate the angle ω formed between each surface of the optical surface 1000 and the X-Y plane will be described. Note that, while a case of the first surface 103a will be exemplified here, ω for another surface can be determined in a similar way. In FIG. 14, “d” denotes a distance along the Z-axis from an incident point “M” where a beam enters the first surface 103a to a viewpoint “X”; “l” denotes a distance along the Y-axis from the incident point “M” to the viewpoint “X”; and ω′ denotes an emission angle of a beam that enters the first surface 103a with angle ω. Here, the following Formulas are established.

tan(π/2+ω−ω′)=d/l (1)

n·sin ω=sin ω′ (2)

Where, n: refractive index of light distribution control member 83; and refractive index of air: 1.

In Formulas (1) and (2), if “d”, “n”, and “l” are determined, ω at an arbitrary position can be calculated. That is, a slant of each surface in an optical surface at an arbitrary position of the light distribution control member 83 at an arbitrary viewpoint can be calculated.

In the backlight in Embodiment 5, since the plural optical surfaces 1000, which have the first, second, and third surfaces 103a, 103b, and 103c and which transforms the direction of the peak component of the beams that are projected from the optical member 107 and that have the narrow-angle light distribution to be directed to each of the directions of the viewpoints “P”, “Q”, and “R”, are provided on the light distribution control member 83, certain brightness at the peripheral portion can be ensured at “P”, “Q”, and “R”.

Because the slant angles of the first and second surfaces 103a and 103b increase as coming close to the peripheral portion of the light distribution control member 83, uniformity of the planar brightness distribution of the backlight can be improved.

In the liquid crystal display device in Embodiment 5, since the above-described backlight is provided, certain brightness at the peripheral portion can be ensured at the viewpoints “P”, “Q”, and “R”.

When the width or arrangement interval (pitch) in the Y-axis direction of the adjacent optical surfaces 1000 on the light distribution control member 83 increases, since the emission direction of beams differ depending on the positions of the display surface 106b of the liquid crystal display panel 106, non-uniformity of the planar brightness in the X-axis direction is observed on the display surface 106b. On the other hand, when the width or pitch is too small, its fabrication becomes difficult and, at the same time, efficiency for light utilization of the light distribution control member 83 decreases.

In general, an image displayed on a liquid crystal display panel is configured with pixels which are basic display units. A pixel is further configured with picture elements of RGB. Intensity of a beam from each of the picture elements is adjusted at the liquid crystal display panel, and a color of a pixel is determined by synthesizing each of the beams with human eyes. When the width and pitch in the Y-axis direction of the optical surfaces 1000 are larger than each RGB picture element size, chromaticity or brightness of a pixel at a viewpoint is sometimes differently observed from chromaticity or brightness to be displayed originally. Thus, it is desirable that the width and pitch of the optical surfaces 1000 are configured to be smaller than the picture element size in its Y-axis direction. It is also desirable that the numbers of optical surfaces 1000 included within the respective RGB picture element widths in their Y-axis direction are each configured to be in a comparable level.

Note that, while the first, second, and third surfaces 103a, 103b, and 103c are described to be planar surfaces in Embodiment 5, this is not a limitation and curved surfaces, etc. may be employed. For example, when concave surfaces are employed, since a light distribution of a beam projected from each of the surfaces can be broadened as described in Embodiments 1 and 2, the decrease in peripheral brightness can be alleviated at a broader range of the viewing distance.

Also, while a case in which the viewpoint “P” is located at the infinite and the third surface 103c is parallel to the X-Y plane is shown in the above, the viewpoint, except for the central portion 110A, may be set at a position other than the infinite, and the third surface 103c may be slanted against the X-Y plane.

In addition, while the optical surface 1000 is shown in Embodiment 5 in which the third, second, and first surfaces 103c, 103b, and 103a are provided from the central portion toward the peripheral portion in this order, the order can be reshuffled.

Furthermore, while a configuration is shown in which the optical surfaces 1000 are provided at the emission surface 83b side of the light distribution control member 83, optical surfaces 1000 may be provided at the incident surface 83a side.

Still further, while the light distribution control member 83 is shown in Embodiment 5 in which the beams that are projected from the optical member 107 and that have the narrow-angle light distribution are transformed to be directed to three viewpoints, i.e. the viewpoint “P” serving as the infinite viewpoint, viewpoint “Q” the middle-distance viewpoint, and viewpoint “R” the short-distance viewpoint, this is not a limitation. The number of viewpoints can be two or more, and the viewing distance can be selected from arbitrary values.

### Embodiment 6

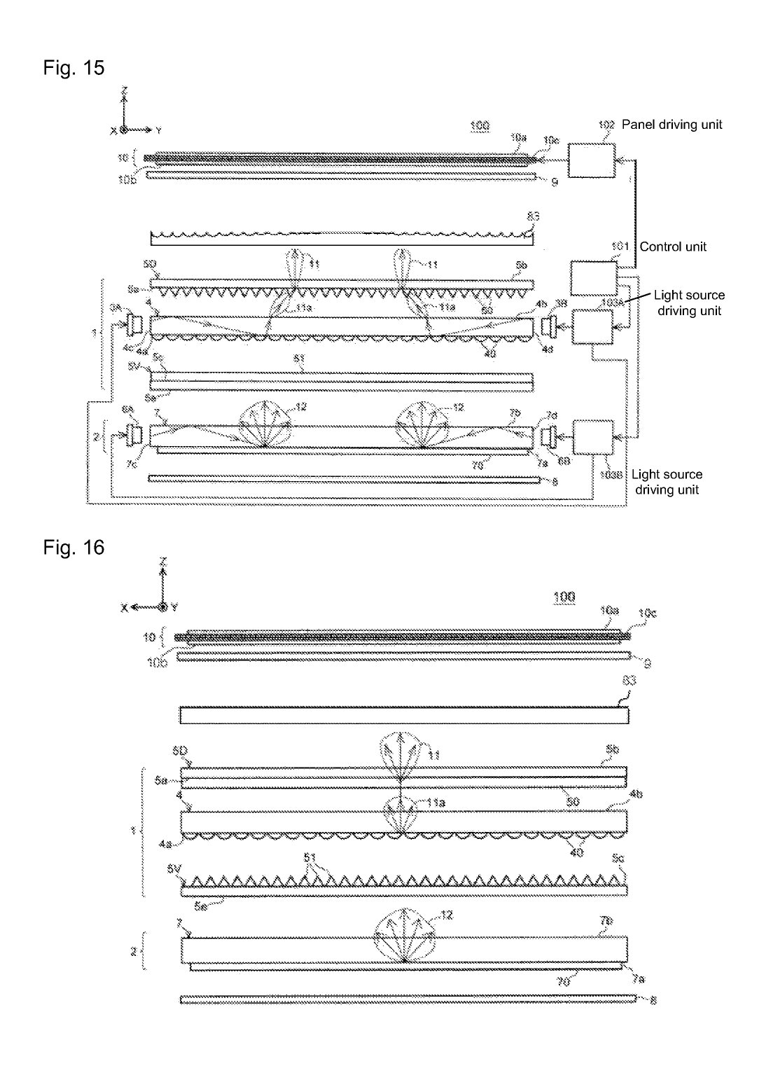

FIG. 15 is a diagram schematically showing a configuration of a liquid crystal display device (liquid crystal display device of transmissive type) 100 in Embodiment 6 according to the present invention. In the liquid crystal display device 100, the light distribution control member 83 in Embodiment 1 is applied to a liquid crystal display device having a variable viewing angle function that will be described later. FIG. 16 is a diagram schematically showing a part of the configuration of the liquid crystal display device 100 in FIG. 15 when viewed from the Y-axis direction. As shown in FIGS. 15 and 16, the liquid crystal display device 100 includes a liquid crystal display panel 10 of a transmissive type, an optical sheet 9, a first backlight unit 1, a second backlight unit 2, a light reflection sheet 8, and the light distribution control member 83. The components referred by numerals 10, 9, 1, 2, 8, and 83 are arranged along the Z-axis. The liquid crystal display panel 10 includes a display surface 10a parallel to the X-Y plane that includes the X-axis and Y-axis orthogonal to the Z-axis. Here, the X-axis and Y-axis are mutually orthogonal. Hereinafter, explanations will be made on the liquid crystal display device, excluding the light distribution control member 83.

The liquid crystal display device 100 further includes a panel driving unit 102 for driving the liquid crystal display panel 10, a light source driving unit 103A for driving light sources 3A and 3B included in the first backlight unit 1, and a light source driving unit 103B for driving light sources 6A and 6B included in the second backlight unit 2. Operations of the panel driving unit 102 and the light source driving units 103A and 103B are controlled by a control unit 101.

Control signals are generated by performing image processing on an image signal supplied by a signal source (not shown) and the control signals are supplied to the panel driving unit 102 and the light source driving units 103A and 103B, by the control unit 101. The light sources 3A/3B and 6A/6B are driven by the light source driving units 103A and 103B in response to the control signal from the control unit 101, and beams are projected from the light sources 3A/3B and 6A/6B, respectively.

In the first backlight unit 1, emission beams from the light sources 3A and 3B are transformed into illumination beams 11 having a narrow-angle light distribution (a distribution in which rays having intensity of no less than a predetermined value are localized within a comparatively narrow angle range centered in the Z-axis direction which is the normal direction of the display surface 10a of the liquid crystal display panel 10), and the beams are projected toward a rear surface 10b of the liquid crystal display panel 10. The illumination beams 11 are projected onto the rear surface 10b of the liquid crystal display panel 10 via the optical sheet 9. The optical sheet 9 is a member for suppressing optical effects of minute non-uniformity of illumination, etc. Meanwhile, in the second backlight unit 2, emission beams from the light sources 6A and 6B are transformed into illumination beams 12 having a wide-angle light distribution (a distribution in which rays having intensity of no less than a predetermined value are localized within a comparatively wide angle range centered in the Z-axis direction), and the beams are projected toward the rear surface 10b of the liquid crystal display panel 10. After transmitting the first backlight unit 1 and optical sheet 9, the illumination beams 12 are projected onto the rear surface 10b of the liquid crystal display panel 10.

The light reflection sheet 8 is provided immediately below the second backlight unit 2. Beams which transmit the second backlight unit 2 from among beams projected from the first backlight unit 1 to its rear surface side, and beams projected from the second backlight unit 2 to its rear surface side, are reflected by the light reflection sheet 8 and utilized as illumination beams for illuminating the rear surface 10b of the liquid crystal display panel 10. As the light reflection sheet 8, a light reflection sheet may be used whose base material is a resin such as polyethylene terephthalate or a light reflection sheet in which a metal is vapor-deposited onto a substrate.

The liquid crystal display panel 10 includes a liquid crystal layer 10c extendedly-provided along the X-Y plane which is orthogonal to the Z-axis. The display surface 10a of the liquid crystal display panel 10 has a rectangular shape, and the X-axis and Y-axis directions shown in FIGS. 15 and 16 are directions along two mutually orthogonal sides of the display surface 10a. Light transmittance of the liquid crystal layer 10c is changed on a pixel unit basis by the panel driving unit 102 in response to the control signal supplied by the control unit 101. Thus, image light can be generated by spatially modulating the illumination beams projected from either or both of the first backlight unit 1 and the second backlight unit 2, and the image light can be projected from the display surface 10a of the liquid crystal display panel 10. When the light sources 3A and 3B are only driven and the light sources 6A and 6B are not driven, since the illumination beams 11 having the narrow-angle light distribution are projected from the first backlight unit 1, a viewing angle of the liquid crystal display device 100 becomes narrow. When the light sources 6A and 6B are only driven, since the illumination beams 12 having the wide-angle light distribution are projected from the second backlight unit 2, a viewing angle of the liquid crystal display device 100 becomes wide. The light source driving units 103A and 103B are separately controlled by the control unit 101 so that an intensity percentage of the illumination beams 11 projected from the first backlight unit 1 and the illumination beams 12 projected from the second backlight unit 2 can be adjusted.

As shown in FIG. 15, the first backlight unit 1 includes the light sources 3A and 3B, a light guide plate 4 provided parallel to the display surface 10a of the liquid crystal display panel 10, an optical sheet 5D (hereinafter called as downward prism sheet 5D), and an optical sheet 5V (hereinafter called as upward prism sheet 5V). The beams projected from the light sources 3A and 3B are transformed into the illumination beams 11 having the narrow-angle light distribution by a combination of the light guide plate 4 and the downward prism sheet 5D (first optical member). The light guide plate 4 is a plate-like member made of a transparent optical material such as an acrylic resin (PMMA), and its rear surface 4a (surface opposite to liquid crystal display panel 10 side) has a configuration in which microscopic optical elements 40, which protrude to the opposite direction of the liquid crystal display panel 10 side, are regularly-arranged along a surface parallel to the display surface 10a. The shape of microscopic optical element 40 forms a part of spherical shape, and the surface thereof has a constant curvature.

The upward prism sheet 5V includes an optical configuration for transmitting the illumination beams 12 that are projected from the second backlight unit 2 and that have the wide-angle light distribution, and further includes an optical configuration for reflecting the beams projected from the rear surface 4a of the light guide plate 4 to return the beams to the direction of the light guide plate 4. The beams projected from the rear surface 4a of the light guide plate 4 are reflected by the upward prism sheet 5V so that their traveling direction will be changed into the direction of the liquid crystal display panel 10, and transmit the light guide plate 4 and the downward prism sheet 5D, thereby being utilized as the illumination beams having the narrow-angle light distribution.

The light sources 3A and 3B are provided face to face with both end surfaces (incident edge surfaces) 4c and 4d of the light guide plate 4 in the Y-axis direction, respectively, and are configured with, for example, plural laser-emitting devices arranged in the X-axis direction. The beams projected from the light sources 3A and 3B enter the light guide plate 4 from the incident end surfaces 4c and 4d thereof, respectively, and transmit through the light guide plate 4 while being reflected totally. During the transmission, a part of the transmitted beams are reflected by the microscopic optical element 40 located at the rear surface 4a of the light guide plate 4, and are projected from the front surface (emission surface) of the light guide plate 4 as illumination beams 11a. The beams transmitting through the light guide plate 4 are transformed by the microscopic optical element 40 into beams that have a light distribution centered in the direction slanted by a predetermined angle from the Z-axis direction, and the transformed beams are projected from the front surface 4b. The beams 11a projected from the light guide plate 4 enter a microscopic optical element 50 of the downward prism sheet 5D, are totally reflected internally by the slanted plane of the microscopic optical element 50, and then are projected from the front surface (emission surface) 5b as the illumination beams 11.

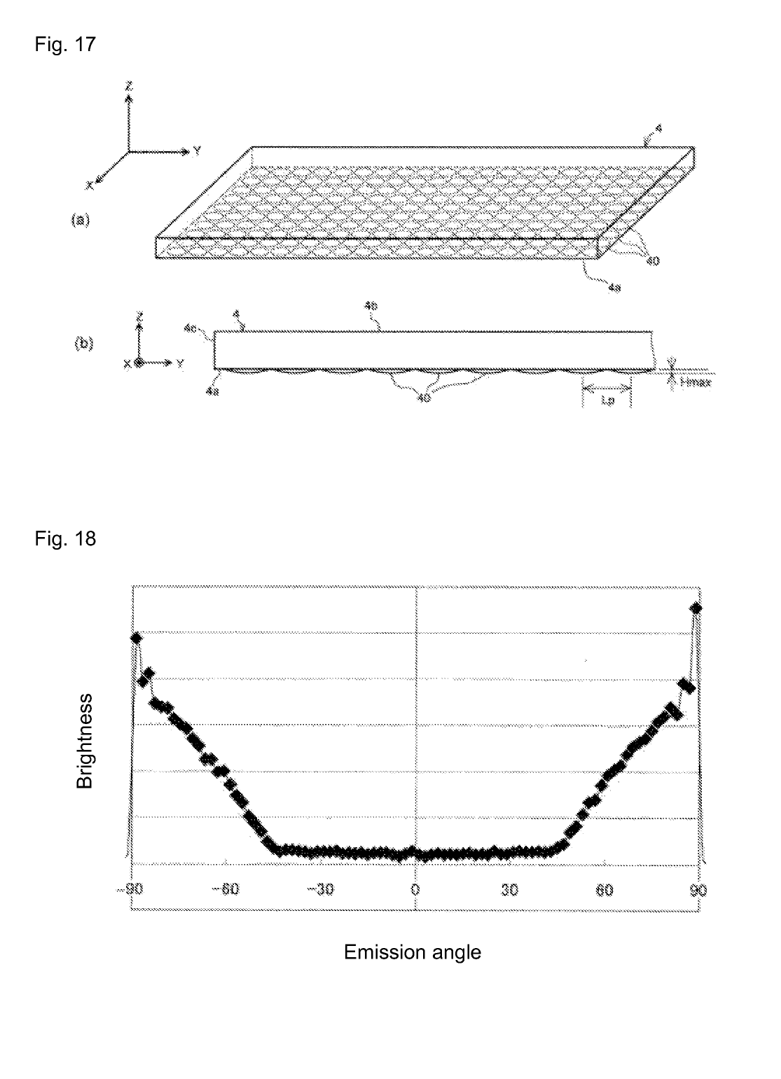

FIG. 17 is a diagram schematically showing an optical configuration example of the light guide plate 4, and (a) in FIG. 17 is a perspective view schematically showing a configuration example of the rear surface 4a of the light guide plate 4 and (b) in FIG. 17 is a diagram schematically showing a part of the configuration of the light guide plate 4 shown in (a) in FIG. 17 when viewed from the X-axis direction. As shown in (a) in FIG. 17, the microscopic optical elements 40 having the convex spherical shape are arranged on the rear surface 4a of the light guide plate 4 in a two-dimensional manner (along X-Y plane).

As a working example of the microscopic optical element 40, a microscopic optical element may be employed having, for example, a surface curvature of about 0.15 mm, a maximum height Hmax of about 0.005 mm, and a refractive index of about 1.49. The distance Lp between the centers of microscopic optical elements 40 may be 0.077 mm. Note that, while the acrylic resin can be employed as a material for the light guide plate 4, the material is not limited thereto. Another resin material such as a polycarbonate resin or a glass material may be used in place of the acrylic resin, as long as the material has high light transmittance and high molding processability.

As described above, the beams projected from the light sources 3A and 3B enter the light guide plate 4 from the lateral end surfaces 4c and 4d thereof, respectively. While transmitting through the light guide plate 4, the incident beams are reflected totally, due to the refractive index difference between the microscopic optical element 40 of the light guide plate 4 and the airspace, and are projected from the front surface 4b of the light guide plate 4 toward the liquid crystal display panel 10. Although the microscopic optical elements 40 shown in (a) and (b) in FIG. 17 are almost regularly-arranged on the rear surface 4a of the light guide plate 4, in order to equalize a planar brightness distribution of the emission beams 11a projected from the front surface 4b of the light guide plate 4, density of the microscopic optical elements 40, i.e. the number of elements per unit area, may be increased as getting away from the end surfaces 4c and 4d, while the density of the microscopic optical elements 40 may be decreased as coming close to the end surfaces 4c and 4d. Alternatively, the microscopic optical elements 40 may be densely formed as coming close to the center of the light guide plate 4 and formed to be sparse gradually as getting away from the center.

FIG. 18 is a graphic chart showing a calculated result of simulation on a light distribution (angle vs. brightness distribution) of the emission beam 11a projected from the front surface 4b of the light guide plate 4. In the graphic chart in FIG. 18, the horizontal axis denotes an emission angle of the emission beam 11a and the vertical axis denotes the brightness. As shown in FIG. 18, the light distribution of the emission beam 11a has two substantially same distribution widths (full width at half maximum (FWHM)) of about 30 degrees with respect to the center axes slanted about ±75 degrees from the Z-axis direction. That is, the emission beam 11a has the light distribution in which rays having the intensity of no less than FWHM are localized at an angle range of between about +60 and +90 degrees centered on the axis slanted by about +75 degrees from the Z-axis direction and at another angle range of between about −60 and −90 degrees centered on the axis slanted by about −75 degrees from the Z-axis direction. Here, the emission beam mainly having the angle range of between −60 and −90 degrees is formed by internally reflecting, with the microscopic optical elements 40, the beam projected from the rightward light source 3B in FIG. 15, and the emission beam mainly having the angle range of between +60 and +90 degrees is formed by internally reflecting, with the microscopic optical elements 40, the beam projected from the leftward light source 3A in FIG. 15. Note that an emission beam having the above-described light distribution can be generated if a prism shape, in place of the convex spherical shape, is employed as a shape of the microscopic optical element 40.

As will be described later, by generating the emission beams 11a localized in these two angle ranges, the emission beams 11a entered the microscopic optical element 50 of the downward prism sheet 5D can be totally reflected by the inner surface of the microscopic optical element 50. The beams totally reflected by the inner surface of the microscopic optical element 50 are localized within a relatively narrow angle range centered in the Z-axis direction, thereby forming the illumination beams 11 having the narrow-angle light distribution.

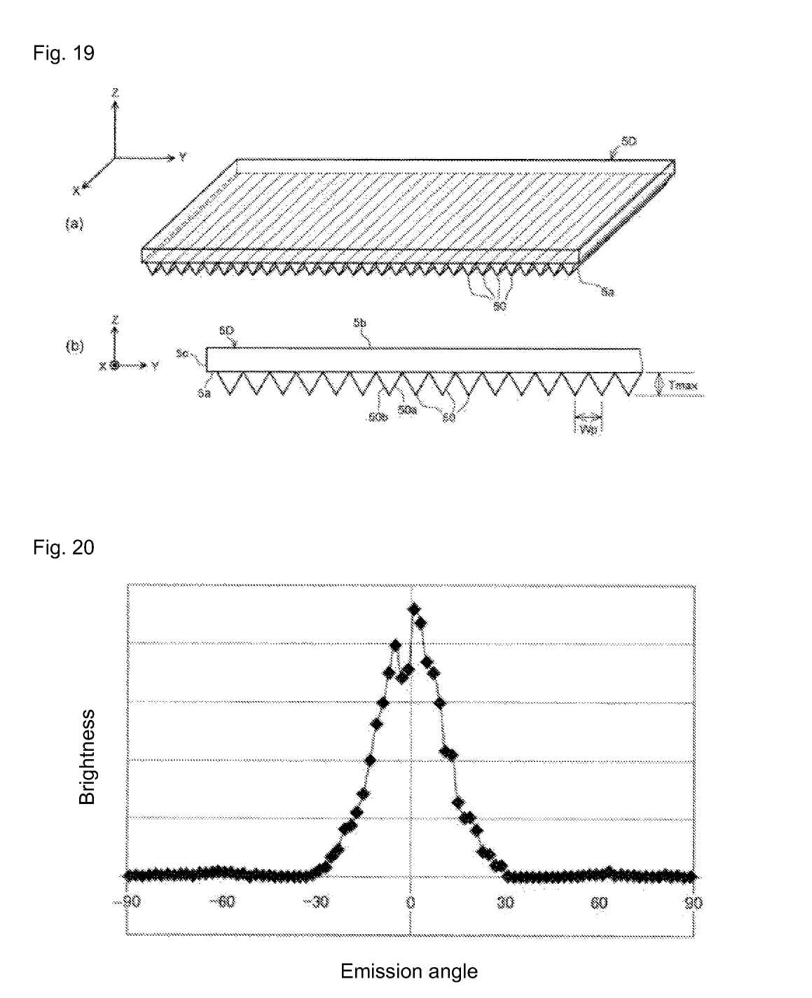

Next, an optical configuration of the downward prism sheet 5D will be described. FIG. 19 is a diagram schematically showing an optical configuration example of the downward prism sheet 5D, and (a) in FIG. 19 is a perspective view schematically showing a configuration example of a rear surface 5a of the downward prism sheet 5D and (b) in FIG. 19 is a diagram schematically showing a part of the configuration of the downward prism sheet 5D shown in (a) in FIG. 19 when viewed from the X-axis direction. As shown in (a) in FIG. 19, the rear surface 5a (i.e. surface facing light guide plate 4) of the downward prism sheet 5D has a configuration in which plural microscopic optical elements 50 are regularly-arranged in the Y-axis direction along a surface parallel to the display surface 10a. Each of the microscopic optical elements 50 forms a convex portion of triangular prism shape. The vertex portion of the microscopic optical element 50 protrudes to the opposite direction of the liquid crystal display panel 10 side, and the ridgeline configuring the vertex portion is extendedly-provided in the X-axis direction. The pitch of the microscopic optical elements 50 is constant. Each of the microscopic optical elements 50 has two slanted planes 50a and 50b, which are slanted from the Z-axis direction to the +Y-axis direction and −Y-axis direction, respectively.

The emission beams 11a projected from the front surface 4b of the light guide plate 4 enter the rear surface 5a of the downward prism sheet 5D, i.e. the microscopic optical element 50. Because the incident beams are totally reflected internally by either of the slanted planes 50a and 50b which configure the triangular prism of the microscopic optical element 50 and then are bent so as to come close to the normal direction of the liquid crystal display panel 10 (Z-axis direction), the incident beams turn into the illumination beams 11 that have high brightness at their center and a light distribution of a narrow distribution width.

As a working example of the microscopic optical element 50, a microscopic optical element may be employed having, for example, a vertex angle, formed by the slanted planes 50a and 50b (vertex angle of isosceles triangle shape at the cross section in (b) in FIG. 19), of 68 degrees, a height Tmax of 0.022 mm, and a refractive index of 1.49. The microscopic optical elements 50 may be arranged so as to have their center distance Wp of 0.03 mm in the Y-axis direction. Note that, while PMMA can be employed as a material for the downward prism sheet 5D, the material is not limited thereto. Another resin material such as a polycarbonate resin or a glass material may be used, as long as the material has high light transmittance and high molding processability.

FIG. 20 is a graphic chart showing a calculated result of simulation on light distribution of the illumination beam 11 projected from a front surface 5b of the downward prism sheet 5D. In the graphic chart in FIG. 20, the horizontal axis denotes an emission angle of the illumination beam 11 and the vertical axis denotes the brightness. Note that the beam projected from the second backlight unit 2 and transmitting the first backlight unit 1 is not included in the light distribution in FIG. 20. As shown in FIG. 20, the light distribution of the illumination beam 11 has a distribution width (full width at half maximum (FWHM)) whose emission angle is about 30 degrees centered in the Z-axis direction. That is, the light distribution of the illumination beam 11 is a narrow-angle light distribution in which rays having the intensity of no less than FWHM are localized at an angle range of between −15 and +15 degrees centered in the Z-axis direction.

The narrow-angle light distribution shown in FIG. 20 is made on the premise that the emission beam 11a from the light guide plate 4 has the light distribution in FIG. 18. The light distribution in FIG. 18 is obtained as a result of designing the light guide plate 4 so as to satisfy the following conditions: (1) The light sources 3A and 3B having an angle intensity distribution of the Lambert shape are used; and (2) The emission beam 11a from the light guide plate 4 is totally reflected internally by the slanted planes 50a and 50b of the microscopic optical element 50 (vertex angle of 68 degrees) of the downward prism sheet 5D and travels through the downward prism sheet 5D, thereby being transformed into the beam having the light distribution localized within the angle range of distribution width of about 30 degrees centered in the 0-degree direction.

FIG. 21 is a diagram schematically showing an optical function of the microscopic optical element 50. As shown in (a) in FIG. 21, in the microscopic optical element 50, a luminous flux IL (mainly, emission beam 11a reflected internally at microscopic optical element 40 of light guide plate 4) entering the slanted plane 50a at an angle of no less than a predetermined value with respect to the Z-axis is totally reflected internally by the slanted plane 50b. As a result, an emission angle of an emitted luminous flux OL is smaller than an incident angle of the incident luminous flux IL. Meanwhile, as shown in (b) in FIG. 21, in the microscopic optical element 50, another luminous flux IL (mainly, illumination beam 12 projected from front surface 7b of light guide plate 7 in second backlight unit 2 and transmitting light guide plate 4) entering the slanted plane 50a at an angle less than the predetermined value with respect to the Z-axis is refracted and projected in the angle direction greatly slanted from the Z-axis direction. As a result, the emission angle of the emitted luminous flux OL is larger than the incident angle of the incident luminous flux IL. Thus, in the downward prism sheet 5D, when the beam, having the light distribution in which rays having intensity of no less than the predetermined value are localized within a comparatively wide angle range centered in the Z-axis direction, enters from the rear surface 5a, the beam can be projected from the front surface 5b with slightly narrowing the width of its light distribution. Therefore, if the illumination beam 12 projected from the front surface 7b of the light guide plate 7 transmits the upward prism sheet 5V, light guide plate 4, and downward prism sheet 5D, its width is not narrowed.

Next, an optical configuration of the upward prism sheet 5V will be described. FIG. 22 is a diagram schematically showing an optical configuration example of the upward prism sheet 5V, and (a) in FIG. 22 is a perspective view schematically showing a configuration example of a surface 5c of the upward prism sheet 5V and (b) in FIG. 22 is a diagram schematically showing a part of the configuration of the upward prism sheet 5V shown in (a) in FIG. 22 when viewed from the Y-axis direction. As shown in (a) in FIG. 22, the surface 5c (surface facing light guide plate 4) of the upward prism sheet 5V has a configuration in which plural microscopic optical elements 51 are regularly-arranged in the X-axis direction along a surface parallel to the display surface 10a. Each of the microscopic optical elements 51 forms a convex portion of triangular prism shape. The vertex portion of the microscopic optical element 51 protrudes to the direction of the liquid crystal display panel 10 side, and the ridgeline configuring the vertex portion is extendedly-provided in the Y-axis direction. The pitch of the microscopic optical elements 51 is constant. Each of the microscopic optical elements 51 has two slanted planes 51a and 51b, which are slanted from the Z-axis direction to the +X-axis direction and −X-axis direction, respectively. The arranging direction (X-axis direction) of the microscopic optical elements 51 of the upward prism sheet 5V is almost orthogonal to the arranging direction (Y-axis direction) of the microscopic optical elements 50 of the downward prism sheet 5D.

As a working example of the microscopic optical element 50 of the upward prism sheet 5V, a microscopic optical element may be employed having, for example, a vertex angle, formed by the slanted planes 51a and 51b (vertex angle of isosceles triangle shape at cross section in (b) in FIG. 22), of 90 degrees, a maximum height Dmax of 0.015 mm, and a refractive index of 1.49. The microscopic optical elements 51 may be arranged so as to have their center distance Gp of 0.03 mm in the X-axis direction. Note that, while PMMA can be employed as a material for the prism sheet, the material is not limited thereto. Another resin material such as a polycarbonate resin or a glass material may be used, as long as the material has high light transmittance and high molding processability.

In the upward prism sheet 5V, by totally reflecting internally the beams (return beams), entering the microscopic optical element 51 from the light guide plate 4, by a rear surface 5e, the traveling direction of the return beams can be changed into the direction of the liquid crystal display panel 10. Examples of the return beams from the light guide plate 4 are beams projected in the opposite direction of the liquid crystal display panel 10 side because the beams do not satisfy the total reflection condition at the rear surface 4a of the light guide plate 4, and beams projected from the downward prism sheet 5D in the opposite direction of the liquid crystal display panel 10 side. Since these return beams can be used again as the illumination beams for the first backlight unit 1 by the upward prism sheet 5V, efficiency for light utilization can be improved.

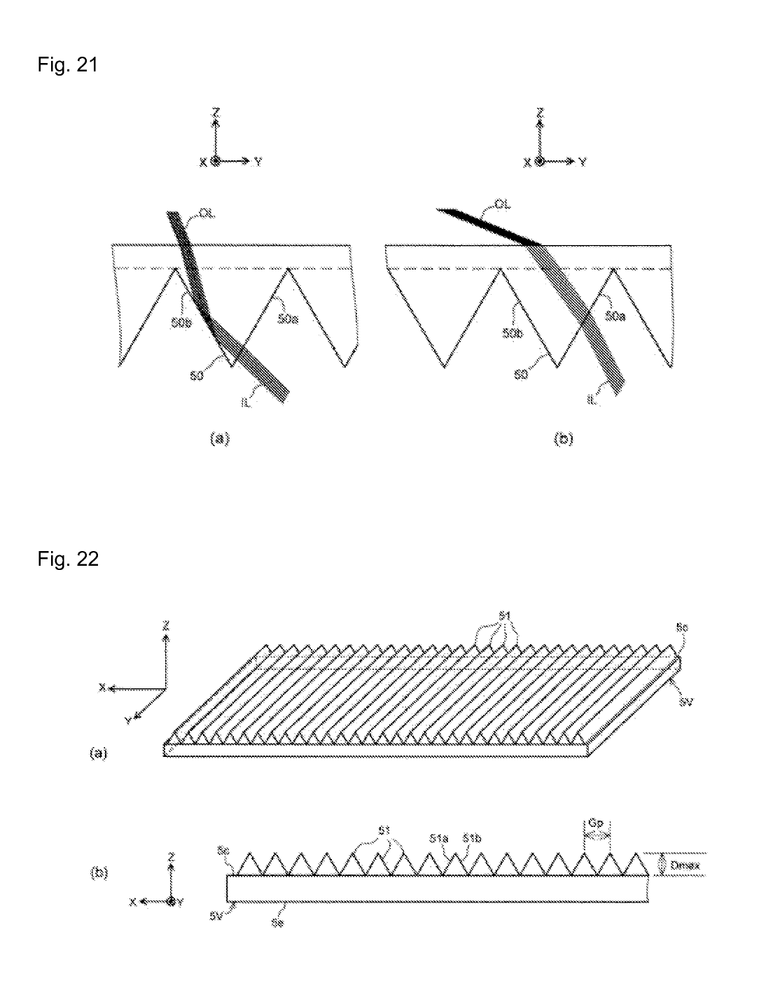

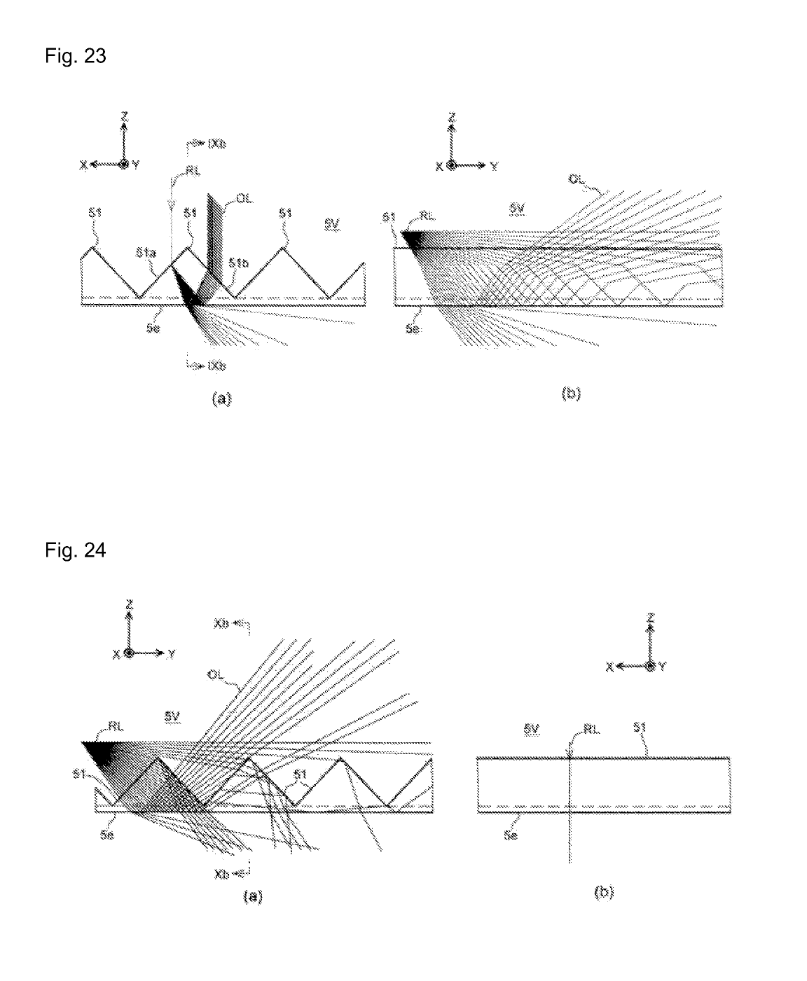

Next, an optical function of the microscopic optical element 51 will be described. FIG. 23 is a diagram schematically showing the optical function of the microscopic optical element 51 of the upward prism sheet 5V. As described above, the arranging direction (X-axis direction) of the microscopic optical elements 51 in Embodiment 6 is almost orthogonal to the arranging direction (Y-axis direction) of the microscopic optical elements 50 of the downward prism sheet 5D. Here, (a) in FIG. 23 is a diagram schematically showing a part of the cross section, parallel to the X-Z plane, of the upward prism sheet 5V having the microscopic optical elements 51, and (b) in FIG. 23 is a partial cross-sectional view, along the IXb-IXb line, of the upward prism sheet 5V shown in (a) in FIG. 23. Meanwhile, FIG. 24 is a diagram schematically showing an optical function of the microscopic optical elements 51 when the arrangement of the upward prism sheet 5V is changed so that the array direction of the microscopic optical elements 51 is parallel to the array direction of the microscopic optical elements 50 of the downward prism sheet 5D. Here, (a) in FIG. 24 is a diagram schematically showing a part of the cross section, parallel to the Y-Z plane, of the upward prism sheet 5V, and (b) in FIG. 24 is a partial cross-sectional view, along the Xb-Xb line, of the upward prism sheet 5V shown in (a) in FIG. 24. In FIGS. 23 and 24, behavior of beams is shown when the return beams RL enter the microscopic optical element 51 from the light guide plate 4. Here, among the actual return beams from the light guide plate 4, the behavior of the beams transmitting along the Y-Z plane is dominant. Therefore, only the return beams RL that transmit in a plane parallel to the Y-Z plane are simplifiedly shown for the descriptive purpose.

As shown in (a) in FIG. 23, each of the microscopic optical elements 51 has a pair of slanted planes 51a and 51b that have a symmetrical slant angle with respect to the Z-axis direction in the X-Z plane. As shown in FIG. 23, beams serving as the return beams RL enter the slanted plane 51a of the microscopic optical element 51 with various incident angles. As shown in (a) in FIG. 23, the beams entering along the Z-axis direction are refracted in the −X-axis direction by the slanted plane 51a. Here, although not shown, the return beams RL also enter the slanted plane 51b of the microscopic optical element 51 and are refracted in the +X-axis direction by the slanted plane 51b. Therefore, because the incident angle of the refracted beams, traveling through the upward prism sheet 5V, against the rear surface 5e is large, refracted beams satisfying the total reflection condition are often generated at the interface (rear surface 5e) between the upward prism sheet 5V and the airspace. In other words, the incident angle of the refracted beams against the rear surface 5e often exceeds the critical angle. Among the refracted beams, the beams OL totally reflected internally by the rear surface 5e are projected in the direction of the liquid crystal display panel 10 as shown in FIG. 23. Especially, since most of the return beams RL from the light guide plate 4 enter the microscopic optical element 51 of the upward prism sheet 5V with an angle greatly slanted from the normal direction (Z-axis direction) of the upward prism sheet 5V, the total reflection condition is often satisfied at the rear surface 5e of the upward prism sheet 5V.

As shown in (a) in FIG. 23, the upward prism sheet 5V has an optical configuration in which plural pairs of slanted planes 51a and 51b of the microscopic optical element 50 are consecutively arranged along the X-axis direction. Meanwhile, as shown in (b) in FIG. 23, since the microscopic optical element 51 is extendedly-provided in the Y-axis direction, the upward prism sheet 5V has a symmetrical configuration with respect to the Z-axis direction in the Y-Z plane. Therefore, when the refracted beams traveling through the upward prism sheet 5V are totally reflected internally by the rear surface 5e, the beams are projected from the upward prism sheet 5V in the direction of the liquid crystal display panel 10 at an angle almost equal to the incident angle (incident angle against Z-axis direction) of the return beams RL to the upward prism sheet 5V in both X-Z plane and Y-Z plane. As shown in (b) in FIG. 23, among the return beams RL, beams having a small incident angle (incident angle against Z-axis direction) against the upward prism sheet 5V are not totally reflected internally by the rear surface 5e, and beams having a comparatively large incident angle are totally reflected internally by the rear surface 5e, thereby being transformed into the emission beams OL. Thus, while a part of the light distribution of the return beams RL are kept, the traveling direction of a part of the return beams RL is changed into the direction of the liquid crystal display panel 10. While transmitting through the light guide plate 4, the emission beams OL are totally reflected internally by the microscopic optical element 50 of the downward prism sheet 5D and are transformed into beams having a light distribution (for example, as shown in FIG. 18, the distribution in which rays having the intensity of no less than FWHM are localized at an angle range of between about +60 and +90 degrees centered on the axis slanted by about +75 degrees from the Z-axis direction and at another angle range of between about −60 and −90 degrees centered on the axis slanted by about −75 degrees from the Z-axis direction) necessary for being transformed into the illumination beams 11 having the narrow-angle light distribution.

In this way, by transmitting through the light guide plate 4 and entering the downward prism sheet 5D, the beams projected from the upward prism sheet 5V in the direction of the liquid crystal display panel 10 are transformed into the illumination beams 11 having high brightness at their center and a light distribution of narrow distribution width, and illuminate the rear surface 10b of the liquid crystal display panel 10. Thus, increased can be the ratio of light quantity of the illumination beams 11 that are projected from the first backlight unit 1 and that have the narrow-angle light distribution to light quantity projected from the light sources 3A and 3B configuring the first backlight unit 1 (the ratio is defined as efficiency for light utilization of the first backlight unit 1). Therefore, since the light quantity of the light source necessary for ensuring predetermined brightness at the display surface 10a can be decreased compared to that of a conventional device, power consumption of the liquid crystal display device 100 can be reduced.

As shown in (a) in FIG. 24, when the arrangement of the upward prism sheet 5V is changed so that the array direction of the microscopic optical elements 51 is parallel to the array direction of the microscopic optical elements 50 of the downward prism sheet 5D, the return beams RL are refracted by the microscopic optical element 51, and a part of the refracted beams are totally reflected internally by the rear surface 5e and are projected in the direction of the liquid crystal display panel 10. Also in this case, although the emission beams OL are transformed into beams having a light distribution substantially the same with that shown in FIG. 18 while transmitting through the light guide plate 4, light quantity of beams projected from the upward prism sheet 5V in the direction of the liquid crystal display panel 10 is reduced compared to the case shown in FIG. 23. As shown in (a) in FIG. 24, if the return beams RL enter the microscopic optical element 51 at a large angle (angle against Z-axis direction) against the upward prism sheet 5V, the traveling direction of the beams in the microscopic optical element 51 is intricately changed by refraction or reflection. When compared to the case shown in (b) in FIG. 23, the percentage of beams increases in which total reflection condition at the rear surface 5e of the upward prism sheet 5V is not satisfied, and the percentage of beams increases that are projected from the rear surface 5e of the upward prism sheet 5V in the opposite direction of the liquid crystal display panel 10 side. Therefore, light quantity of beams that are totally reflected internally by the upward prism sheet 5V and that are projected in the direction of the liquid crystal display panel 10 is reduced. Thus, from the standpoint of obtaining a strong effect for reducing power consumption, it is preferable that the array direction of the microscopic optical elements 51 of the upward prism sheet 5V is almost orthogonal to the array direction of the microscopic optical elements 50 of the downward prism sheet 5D.

The liquid crystal display device 100 in Embodiment 6 has a configuration in which the first backlight unit 1 and the second backlight unit 2 are stacked, and the first backlight unit 1 is provided between the second backlight unit 2 and the liquid crystal display panel 10. Because the illumination 12 that is projected from the second backlight unit 2 and that has the wide-angle light distribution is necessary to be transmitted through the first backlight unit 1, it is not preferable in the first backlight unit 1 that a light reflection sheet, like the light reflection sheet 8, having low light transmittance and high reflectivity is used as a means for reflecting the return beams RL in the direction of the liquid crystal display panel 10. Since the first backlight unit 1 does not use such kind of light reflection sheet and has the upward prism sheet 5V having very high light transmittance, the increase of power consumption can be reduced without decreasing the ratio of light quantity of the beams that are projected from the display surface 10a of the liquid crystal display device 100 and that have the wide-angle light distribution to light quantity projected from the light sources 6A and 6B configuring the second backlight unit 2 (the ratio is defined as efficiency for light utilization of the second backlight unit 2).

The light reflection sheet 8 is provided so that the return beams transmitted from the first backlight unit 1 and the second backlight unit 2 will be reflected in the direction of the liquid crystal display panel 10 and reutilized as the illumination beams. Here, the beams entering the surface of the light reflection sheet 8 are beams that are diffused by a diffusion reflection structure 70 of the second backlight unit 2 and that have the wide-angle light distribution, and the beams reflected by the surface of the light reflection sheet 8 in the direction of the liquid crystal display panel 10 are diffused when reflected by the surface of the light reflection sheet 8 or when transmitting through the diffusion reflection structure 70. Therefore, in the beams that enter the first backlight unit 1 from the rear surface side thereof, the percentage of beams is decreased that have the angle necessary for being transformed into the illumination beams 11 having the narrow-angle light distribution. Meanwhile, as described above, the beams can be projected from the upward prism sheet 5V, which have the light distribution necessary for the incident beams that enter the downward prism sheet 5D to be totally reflected internally by the microscopic optical element 50 and to be transformed into the illumination beams 11 having the narrow-angle light distribution. Thus, since the return beams RL that enter from the light guide plate 4 are efficiently transformed into the beams having the narrow-angle light distribution centered in the normal direction of the display surface 10a of the liquid crystal display panel 10, efficiency for light utilization in the first backlight unit 1 can be improved.

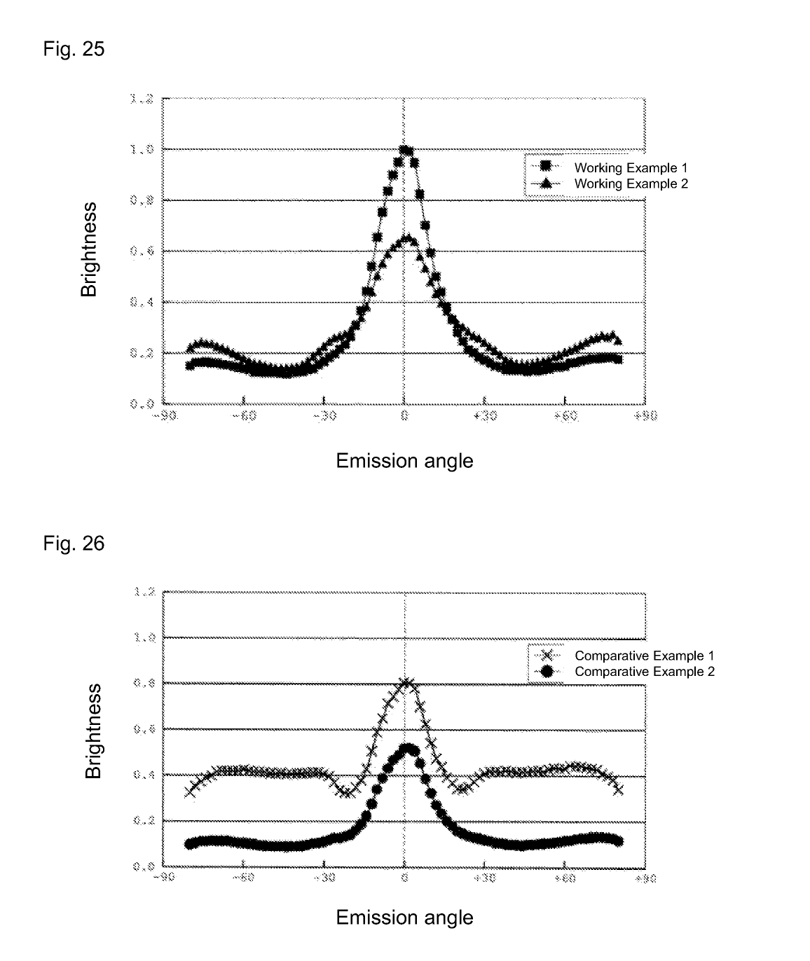

FIGS. 25 and 26 are graphic charts showing experimentally measured results of angle vs. brightness distribution (light distribution) of beams projected from backlight units having mutually different configurations. In the graphic charts in FIGS. 25 and 26, the horizontal axis denotes an emission angle of an emission beam and the vertical axis denotes normalized brightness. In FIG. 25, two light distributions are shown, i.e. the light distribution of the beam projected in the direction of the liquid crystal display panel 10 in the working example (Working Example 1) of the first backlight unit 1 in Embodiment 6, and the light distribution of the beam projected from the backlight unit in Working Example 2 in the direction of the liquid crystal display panel 10, when the backlight unit is configured by changing the arrangement of the upward prism sheet 5V so that the array direction of the microscopic optical elements 51 is parallel to the array direction of the microscopic optical elements 50 of the downward prism sheet 5D. In FIG. 26, two light distributions are shown, i.e. the light distribution of the beam projected from the backlight unit in Comparative Example 1 in the direction of the liquid crystal display panel 10, when the backlight unit is configured by providing a light reflection sheet having the same structure with the light reflection sheet 8 in place of the upward prism sheet 5V in the first backlight unit 1 in Embodiment 6, and the light distribution of the beam projected from the backlight unit in Comparative Example 2 in the direction of the liquid crystal display panel 10, when the backlight unit is configured by providing a light absorption sheet in place of the upward prism sheet 5V in the first backlight unit 1 in Embodiment 6. In the graphic charts in FIGS. 25 and 26, the brightness is normalized so that the maximum peak brightness in the light distribution of the emission beam in Working Example 1 has a value of one. Note that, in the experiments, the beams having the same light quantity are projected from the light sources 3A and 3B in the all cases of Working Example 1, Working Example 2, Comparative Example 1, and Comparative Example 2.

Since it is obvious from FIG. 25 that the light quantity of emission beam in Working Example 1 is higher than that in Working Example 2, efficiency for light utilization in generating the illumination beam having the narrow-angle light distribution is considered to be high. As shown in FIG. 25, in the light distribution of emission beam in Working Examples 1 and 2, the brightness distribution is sufficiently localized within the angle range of 30 degrees (angle range of between −15 and +15 degrees) centered on 0-degree point. Meanwhile, as shown in FIG. 26, in the light distribution of emission beam in Comparative Example 1, since brightness of more than about 0.4 is observed at the ranges of less than −30 degrees and more than +30 degrees, the narrow-angle light distribution is not obtained. In addition, as it is obvious from FIG. 26, the maximum peak brightness in the light distribution of emission beam in Comparative Example 2 is merely about 0.5.

Next, a configuration of the second backlight unit 2 will be described. As shown in FIG. 15, the second backlight unit 2 includes the light sources 6A and 6B, which are configured similarly to the light sources 3A and 3B of the first backlight unit 1; and the light guide plate 7 provided to be substantially parallel to the rear surface 4a of the light guide plate 4 and to be facing the rear surface 4a. The light guide plate 7 is a plate-like member made of a transparent optical material such as a PMMA, and its rear surface 7a has the diffusion reflection structure 70. The light sources 6A and 6B are provided face to face with both end surfaces (incident edge surfaces) 7c and 7d of the light guide plate 7 in the Y-axis direction, respectively. Similar to the case of the first backlight unit 1, the beams projected from the light sources 6A and 6B enter the light guide plate 7 from the incident end surfaces 7c and 7d thereof, respectively. The incident beams transmit through the light guide plate 7 while being reflected totally, and a part of the transmitted beams are diffusely reflected by the diffusion reflection structure 70, to be projected from the front surface 7b of the light guide plate 7 as the illumination beams 12. The diffusion reflection structure 70 may be configured by coating, for example, a diffusion reflection material on the rear surface 7a. Because the transmitted beams are diffused in a wide angle range by the diffusion reflection structure 70, the illumination beams 12 projected from the second backlight unit 2 are projected toward the liquid crystal display panel 10 as the illumination beams having the wide-angle light distribution.

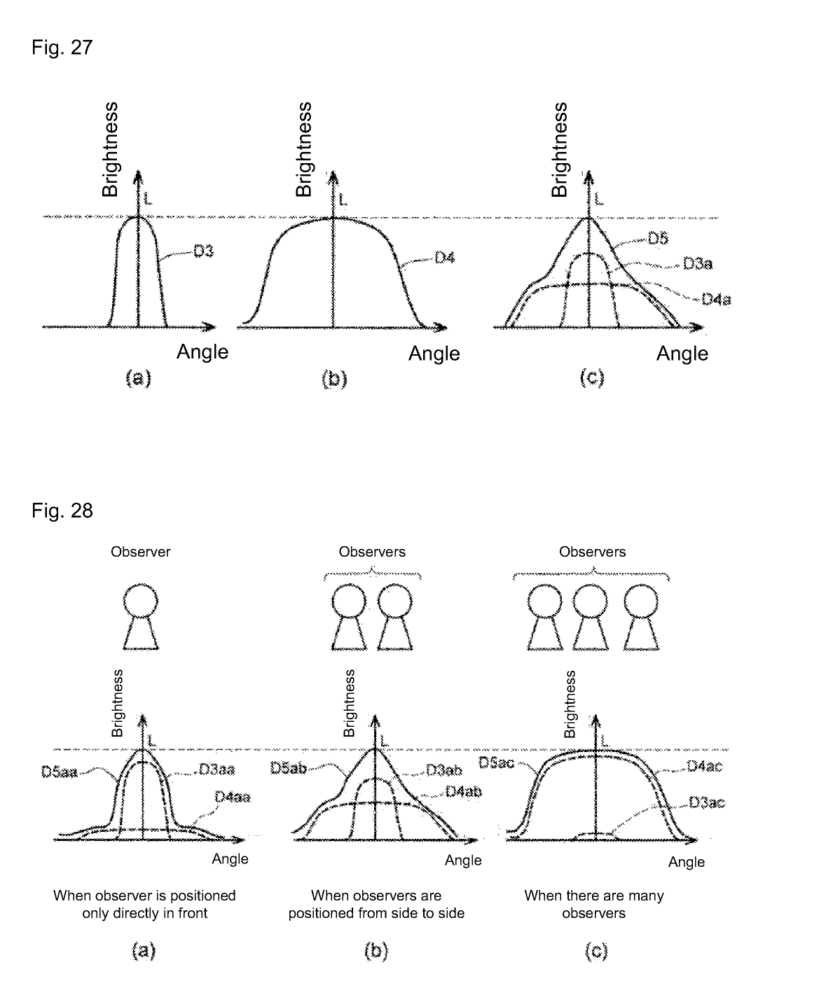

In the liquid crystal display device 100 having the above described configuration, the light distribution of illumination beams for the rear surface 10b of the liquid crystal display panel 10 can be made not only to be the narrow-angle light distribution or the wide-angle light distribution, but also to be an intermediate light distribution between the narrow-angle light distribution and the wide-angle light distribution. FIG. 27 is a diagram schematically exemplifying three types of light distribution of the illumination beams. When the light sources 3A and 3B of the first backlight unit 1 are turned on and the light sources 6A and 6B of the second backlight unit 2 are turned off, the rear surface 10b of the liquid crystal display panel 10 is illuminated by the illumination beams having the narrow-angle light distribution of D3 shown in (a) in FIG. 27. Thus, while an observer can visually recognize a bright image when viewing the liquid crystal display device 100 from directly in front, the observer visually recognizes a dark image when viewing the display surface 10a from its diagonal direction. At that time, since the beams are not projected from the liquid crystal display panel 10 in the unnecessary direction other than the observing direction, the luminescence amount of the light sources 3A and 3B can be suppressed to a small amount and power consumption can be reduced.

Meanwhile, when the light sources 6A and 6B of the second backlight unit 2 are turned on and the light sources 3A and 3B of the first backlight unit 1 are turned off, the rear surface of the liquid crystal display panel 10 is illuminated by the illumination beams having the wide-angle light distribution of D4 shown in (b) in FIG. 27. Thus, the observer can visually recognize a bright image from a wide angle direction, and a large luminescence amount is necessary for the light sources 6A and 6B in order to ensure sufficient brightness in all angle directions, thereby increasing the power consumption.

In the liquid crystal display device 100 in Embodiment 6, the luminescence amount of the light sources 3A and 3B of the first backlight unit 1 and the luminescence amount of the light sources 6A and 6B of the second backlight unit 2 are controlled by the control unit 101 according to the observing direction. For example, as shown in (c) in FIG. 27, the illumination beams 12 of the first backlight unit 1 and the illumination beams 11 of the second backlight unit 2 are generated and a light distribution D5 of intermediate state are formed by superimposing a light distribution D3a of the illumination beams 12 on a light distribution D4a of the illumination beams 11, by the control unit 101. As a result, the most suitable light distribution D5 according to the observing direction can be obtained. Thus, the viewing angle can be obtained according to the observing direction, and the beams projected in the unnecessary direction can be minimized. Therefore, compared to the case ((b) in FIG. 27) in which the illumination beams having the wide-angle light distribution D4 are projected so that the bright image can be visually recognized from the wide observing direction, the total luminescence amount of the light sources 3A, 3B, 6A, and 6B can be reduced, thereby enabling to obtain a strong effect for reducing power consumption.

FIG. 28 is a diagram schematically showing an example of three types of viewing angle control. In the example in FIG. 28, the viewing angle control is made based on a relationship with the area of observers. As shown in (a) in FIG. 28, when the observer is positioned directly in front of the liquid crystal display panel 10, the luminescence amount of the first backlight unit 1 is set to be relatively larger than the luminescence amount of the second backlight unit 2, and thus a narrow-angle light distribution D5aa is generated by the control unit 101, by superimposing a light distribution D3aa of the first backlight unit 1 on a light distribution D4aa of the second backlight unit 2 (narrow viewing angle display mode). Meanwhile, as shown in (b) in FIG. 28, when the area of the observers is broadened from side to side, the ratio of the luminescence amount of the second backlight unit 2 to the luminescence amount of the first backlight unit 1 is set to be increased according to the broadening, and thus a wide-angle light distribution D5ab can be generated by the control unit 101, by superimposing a light distribution D3ab of the first backlight unit 1 on a light distribution D4ab of the second backlight unit 2 (first wide viewing angle display mode). As shown in (c) in FIG. 28, when the area of the observers is further broadened from side to side, the ratio of the luminescence amount of the second backlight unit 2 to the luminescence amount of the first backlight unit 1 is set to be further increased according to the broadening, and thus a wide-angle light distribution D5ac can be generated by superimposing a light distribution D3ac of the first backlight unit 1 on a light distribution D4ac of the second backlight unit 2, by the control unit 101 (second wide viewing angle display mode). In this way, as the area of the observers is broadened from side to side, the ratio of the luminescence amount of the second backlight unit 2 to the luminescence amount of the first backlight unit 1 is set to be increased by the control unit 101 according to the broadening, so that a finely-tuned viewing angle control can be made. In addition, a strong effect for reducing power consumption can be obtained.

Because the observer feels the glare when the display surface 10a of the liquid crystal display device 100 is too bright, excessive brightness is not necessary. Therefore, as shown in FIGS. 27 and 28, when the light distribution of the illumination beams for the rear surface 10b of the liquid crystal display panel 10 is adjusted, the luminescence amount of the light sources 3A, 3B, 6A, and 6B can be controlled by the control unit 101 so that the brightness directly in front of the liquid crystal display panel 10 will be always kept in a constant value “L”.

In the first backlight unit 1 and the second backlight unit 2, it is desirable that the light sources 3A, 3B, 6A, and 6B have the same luminescence system. The reason is that, when the viewing angle is modified by changing the percentage of the luminescence amount of the first backlight unit 1 and the luminescence amount of the second backlight unit 2, possibility can be avoided in which luminescence color change etc. is generated, caused by the difference of luminescence characteristics (emission spectrum, etc.) between the light sources 3A, 3B, 6A, and 6B. By using the same luminescence system in the first backlight unit 1 and the second backlight unit 2, this possibility can be avoided and good image quality can be maintained when the viewing angle is changed. Examples of the light sources having the same luminescence system are illuminants having the same structure, illuminants having the same luminescence characteristics such as luminescence wavelength band, illuminant modules including the same combination of plural illuminants having different luminescence characteristics, or illuminants driven by the same driving method.

In a liquid crystal display device having the above-described variable viewing angle function, the decrease in peripheral brightness also happens as the viewpoint changes, as described above. Therefore, in the liquid crystal display device 100, the light distribution control member 83 in Embodiment 1 is provided between the backlight unit 1 and the liquid crystal display panel 10. Thus, in the liquid crystal display device having the variable viewing angle function, the decrease in peripheral brightness due to the change in the viewing distance can be reduced even if the viewing angle is narrowed.

Note that, while the microscopic optical element 40 has the convex spherical shape as shown in FIG. 17, this is not a limitation. A structure may be employed in place of the microscopic optical element 40 as long as the structure has a function of projecting the emission beams 11a that generate the illumination beams 11 having the narrow-angle light distribution by creating the total internal reflection at the microscopic optical element 50 of the downward prism sheet 5D.

As described above, in the liquid crystal display device 100 in Embodiment 6, the viewing angle can be controlled by adjusting the percentage of the luminescence amount of the first backlight unit 1 and the luminescence amount of the second backlight unit 2, without using complicated and expensive active optical devices. Therefore, since the beams projected from the display surface 10a in the unnecessary direction are minimized in the liquid crystal display device 100, the viewing angle control function effective for reducing the power consumption can be obtained. The liquid crystal display device 100 in Embodiment 6 has a configuration that is simple and low-cost, and that is effective without depending on the screen size, i.e. from small through large size. Because the luminescence amount and the luminescence direction of the first backlight unit 1 and the second backlight unit 2 can be controlled accurately and easily in the liquid crystal display device 100, the viewing angle can be changed in a finely-tuned and optimum manner without generating the color change, etc. of the display image.

The illumination beams 11 having the narrow-angle light distribution can be generated, without using active optical devices, using the light guide plate 4 of the first backlight unit 1 and the downward prism sheet 5D. As described above, by totally reflecting internally the illumination beams 11a, which enter from the front surface 4b of the light guide plate 4, by the slanted planes 50a and 50b, the illumination beams 11 having the narrow-angle light distribution can be generated by the microscopic optical element 50 formed on the rear surface 5a of the downward prism sheet 5D.

Since the first backlight unit 1 has the upward prism sheet 5V, also in the liquid crystal display device 100 of a backlight laminating type in Embodiment 6, the efficiency for light utilization of the first backlight unit 1 can be improved without the loss of the emission beams from the second backlight unit 2. As described above, because the return beams RL projected from the light guide plate 4 of the first backlight unit 1 in the rear surface direction thereof are refracted by the microscopic optical element 51 of the upward prism sheet 5V and then are totally reflected by the rear surface 5e in the direction of the liquid crystal display panel 10, the beams can become the illumination beams 11.

The illumination beams 12 projected from the second backlight unit 2 can illuminate the rear surface of the liquid crystal display panel 10 without narrowing the width of their light distribution by the slanted planes 50a and 50b of the microscopic optical element 50 protruded in the rear surface side. As a configuration for achieving the narrow viewing angle, employed may be a combination of a sheet-like light source emitting illumination beams having the wide-angle light distribution and an optical structure for condensing the illumination beams and transforming the beams into illumination beams having the narrow-angle light distribution (for example, an optical structure whose surface not facing the sheet-like light source is an emission surface). However, in this configuration, since the emission beams from the sheet-like light source are transformed into beams having the narrow-angle light distribution, even the illumination beams that are projected from the second backlight unit 2 and that have the wide-angle light distribution are also made narrow-angled. Thus, it is impossible to obtain the desired light distribution shown in FIG. 27 by superimposing the illumination beams having the narrow-angle light distribution on the illumination beams having the wide-angle light distribution. In the microscopic optical element 50 in Embodiment 6, the illumination beams 12 from the second backlight unit 2 are not condensed and the wide-angle light distribution of the beams is not narrow-banded. Therefore, a finely-tuned viewing angle control can be made even if the configuration in Embodiment 6 is employed in a liquid crystal display device configured with laminating two or more layers of backlight units.

As shown in FIG. 15, because the light sources 3A and 3B are provided at the lateral sides of the light guide plate 4 and the light sources 6A and 6B are provided at the lateral sides of the light guide plate 7 in Embodiment 6, a thin-type configuration having a small thickness in the Z-axis direction can be achieved even if the liquid crystal display device is configured with laminating two or more layers of backlight units. Thus, a thin-type liquid crystal display device having the viewing angle control function can be achieved.

In Embodiment 6, since the luminescence amounts of the first backlight unit 1 and the second backlight unit 2 are independently controlled by the control unit 101 while keeping the brightness directly in front of the display surface 10a at the predetermined commanded value “L”, excessive brightness is not supplied and the most suitable light distribution according to the observing direction can be obtained. In addition, because the beams projected in the unnecessary direction are minimized, the power consumption can be greatly reduced.

In order to control the light distribution of the illumination beams for the rear surface of the liquid crystal display panel 10, it is desirable that the luminescence amount of the light sources 3A, 3B, 6A, and 6B can be controlled freely. From such a standpoint, it is desirable to use a solid-state light source, such as a laser light source or a light-emitting diode, whose luminescence amount can be easily controlled. In this way, more optimal viewing angle control can be made.

In order that the illumination beams 11 projected from the first backlight unit 1 have the narrow-angle light distribution, as described above, the illumination beams 11a projected from the light guide plate 4 are necessary to have the light distribution localized in the angle range which is greatly slanted from the normal direction of the surface (Z-axis direction). It is desirable that the directivity of the beams transmitting through the light guide plate 4 is high, because, if so, the emission angle of the beams projected from the light guide plate 4 can be easily controlled and the narrowing of the width of the light distribution (rays having intensity of no less than a predetermined value are localized within a specific angle range) is possible. Therefore, it is desirable to use a laser light source having high directivity as the light sources 3A and 3B. Thus, the viewing angle can be controlled in a finely-tuned and optimum manner and, at the same time, a strong effect for reducing power consumption can be obtained.

In Embodiment 6, while both end surfaces of the light guide plate 4 in its Y-axis direction work as light incident surfaces and the light sources 3a and 3b which are located face to face with these end surfaces are provided in the first backlight unit 1, the configuration is not limited to this. The first backlight unit 1 may be configured such that only one end surface of both end surfaces of the light guide plate 4 works as a light incident surface and a light source which is located face to face with this end surface is provided. In this case, it is desirable that the planar brightness distribution of the beams projected from the light guide plate 4 is equalized by appropriately changing the arrangement interval and the specifications of the microscopic optical elements 40 provided on the rear surface 4a of the light guide plate 4. Similarly, the second backlight unit 2 may be configured such that only one end surface of both end surfaces of the light guide plate 7 works as a light incident surface and a light source which is located face to face with this end surface is provided.

While the light distribution control member in Embodiment 1 is used as the light distribution control member 83 in Embodiment 6, the configuration is not limited to this. Any one of the light distribution control members in Embodiments 2 through 5, or a variant thereof can be employed.

### Embodiment 7

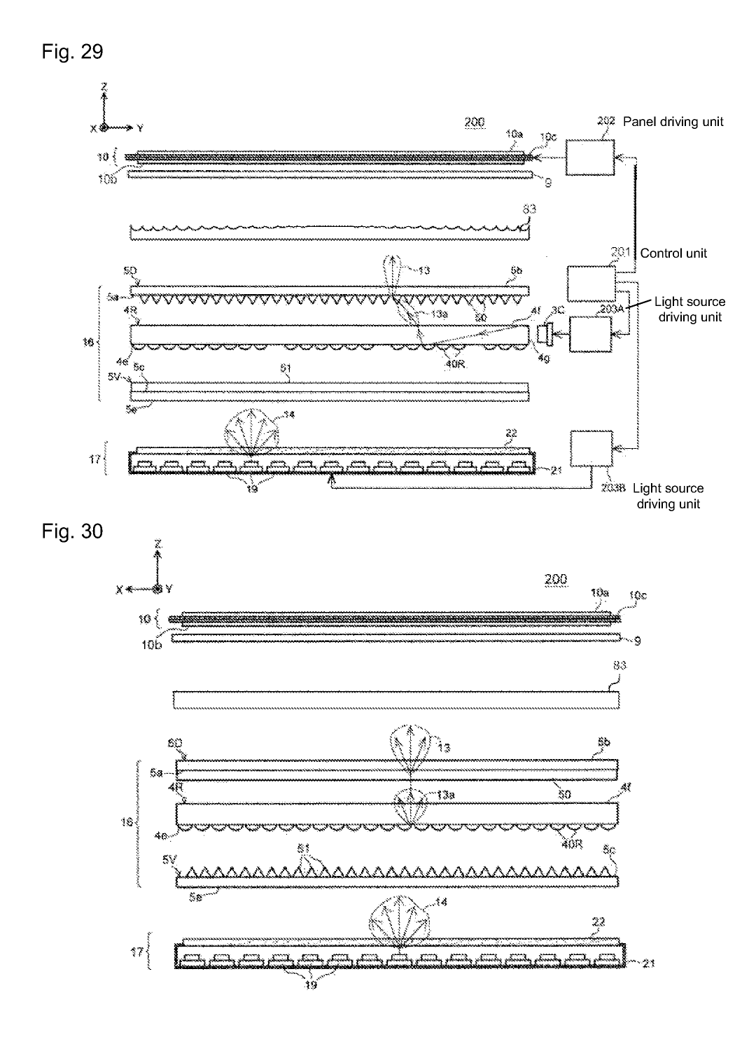

FIG. 29 is a diagram schematically showing a configuration of a liquid crystal display device 200 (liquid crystal display device of transmissive type) in Embodiment 7 according to the present invention. In the liquid crystal display device 200, the light distribution control member 83 in Embodiment 1 is applied to a liquid crystal display device having a variable viewing angle function. FIG. 30 is a diagram schematically showing a part of the configuration of the liquid crystal display device 200 in FIG. 29 when viewed from the Y-axis direction. Among configuring elements of the liquid crystal display device 200 in FIGS. 29 and 30, those referred by the same numeral with that in FIG. 15 are assumed to have the same function, and the detailed explanation thereof will be skipped.

As shown in FIGS. 29 and 30, the liquid crystal display device 200 includes the liquid crystal display panel 10 of a transmissive type, the optical sheet 9, a first backlight unit 16, a second backlight unit 17, and the light distribution control member 83. Configuring elements referred by numerals 10, 9, 16, 17, and 83 are arranged along the Z-axis. Hereinafter, explanations will be made on the liquid crystal display device, excluding the light distribution control member 83. Similar to Embodiment 6, the liquid crystal display panel 10 includes a display surface 10a parallel to the X-Y plane that includes the X-axis and Y-axis orthogonal to the Z-axis. Here, the X-axis and Y-axis are mutually orthogonal. The liquid crystal display device 200 further includes a panel driving unit 202 for driving the liquid crystal display panel 10, a light source driving unit 203A for driving a light source 3C included in the first backlight unit 16, and a light source driving unit 203B for driving light sources 19 included in the second backlight unit 17. Operations of the panel driving unit 202 and the light source driving units 203A and 203B are controlled by a control unit 201.

A control signal is generated by performing image processing on an image signal (not shown) supplied by a signal source (not shown), and the control signal is supplied to the panel driving unit 202 and the light source driving units 203A and 203B by the control unit 201. The light sources 3C and 19 are driven by the light source driving units 203A and 203B according to the control signal from the control unit 201, and beams are projected from the light sources 3C and 19, respectively.

In the first backlight unit 16, emission beams from the light sources 3C are transformed into illumination beams 13 having a narrow-angle light distribution (a distribution in which rays having intensity of no less than a predetermined value are localized within a comparatively narrow angle range centered in the Z-axis direction which is the normal direction of the display surface 10a of the liquid crystal display panel 10), and the beams 13 are projected toward a rear surface of the liquid crystal display panel 10. The illumination beams 13 are projected onto the rear surface of the liquid crystal display panel 10 via the optical sheet 9. Meanwhile, in the second backlight unit 17, emission beams from the light sources 19 are transformed into illumination beams 14 having a wide-angle light distribution (a distribution in which rays having intensity of no less than a predetermined value are localized within a comparatively wide angle range centered in the Z-axis direction), and the beams 14 are projected toward the first backlight unit 16. After transmitting the first backlight unit 16, the illumination beams 14 are projected onto the rear surface of the liquid crystal display panel 10 via optical sheet 9.

As shown in FIGS. 29 and 30, the first backlight unit 16 includes the light source 3C, a light guide plate 4R provided parallel to the display surface 10a of the liquid crystal display panel 10, the downward prism sheet 5D, and the upward prism sheet 5V. A configuration of the first backlight unit 16 can be obtained by replacing the light guide plate 4 of the first backlight unit 1 in Embodiment 6 with the light guide plate 4R. The light guide plate 4R is configured with a plate-like member formed by a transparent optical material such as an acrylic resin (PMMA). A rear surface 4e (surface opposite to liquid crystal display panel 10 side) of the light guide plate 4R has a configuration in which microscopic optical elements 40R are arranged along a surface parallel to the display surface 10a. The shape of microscopic optical element 40R forms a part of spherical shape, and the surface thereof has a constant curvature.

The light source 3C is provided face to face with an end surface 4g (incident edge surface) of the light guide plate 4R in the Y-axis direction, and is configured with arranging, for example, plural light-emitting diodes in the X-axis direction. The beams projected from the light source 3C enter the light guide plate 4R from the incident end surface 4g of the light guide plate 4R and transmit through the light guide plate 4R while being reflected totally. During the transmission, a part of the transmitted beams are reflected by the microscopic optical element 40R located at the rear surface 4e of the light guide plate 4R, and are projected from a front surface 4f of the light guide plate 4R as illumination beams 13a. The beams transmitting through the light guide plate 4R are transformed by the microscopic optical element 40R into beams that have a light distribution centered in the direction slanted by a predetermined angle from the Z-axis direction, and the transformed beams are projected from the front surface 4f. After entering the downward prism sheet 5D, the beams 13a projected from the light guide plate 4R are totally reflected internally by the microscopic optical element 50 in FIGS. 29 and 30, and then are projected from the front surface 5b (emission surface) as the illumination beams 13.

The microscopic optical element 40R can be the same shape as the microscopic optical element 40 in Embodiment 6. The material for the light guide plate 4R having the microscopic optical elements 40R can be the same material as the light guide plate 4 in Embodiment 6. Thus, as a working example of the microscopic optical element 40R, a microscopic optical element may be employed having, for example, a surface curvature of about 0.15 mm, a maximum height of about 0.005 mm, and a refractive index of about 1.49.

The pitch of centers of the microscopic optical elements 40R are set to be smaller as the distance from the incident edge surface 4g, in which the incident beams from the light source 3C enter, becomes larger, and to be larger as the distance from the incident edge surface 4g becomes smaller. As described above, the incident beams from the light source 3C enter the light guide plate 4R through the incident edge surface 4g located at the lateral side of the light guide plate 4R. While transmitting through the light guide plate 4R, the incident beams are reflected totally, due to the refractive index difference between the microscopic optical element 40R of the light guide plate 4R and the airspace, and is projected from the front surface 4f of the light guide plate 4R in the direction of the liquid crystal display panel 10. Here, the microscopic optical elements 40R are more sparsely formed as coming close to the incident edge surface 4g located near the light source 3C (i.e. the number of the microscopic optical elements 40R per unit area (density) decreases as coming close to the incident edge surface 4g), while more densely formed as getting away from the light source 3C (i.e. the density of the microscopic optical elements 40R increases as getting away from the incident edge surface 4g). The reason is to equalize a planar brightness distribution of the emission beams 13a. Since the beam intensity becomes high as coming close to the incident edge surface 4g, the density of the microscopic optical element 40R is lowered so that percentage of the transmitted beams totally reflected internally by the microscopic optical element 40R will be decreased. Meanwhile, because the beam intensity becomes low as getting away from the incident edge surface 4g, the density of the microscopic optical element 40R is raised so that percentage of the transmitted beams totally reflected internally by the microscopic optical element 40R can be increased. Thus, it is possible to equalize the planar brightness distribution of the emission beams 13a.

Similar to the case in Embodiment 6, the beams enter the front surface 5c of the upward prism sheet 5V include beams projected from the rear surface 4e of the light guide plate 4R because the beams do not satisfy the total reflection condition at the surface, and beams projected from the downward prism sheet 5D in the opposite direction of the liquid crystal display panel 10 side. In the upward prism sheet 5V, by totally reflecting internally the beams (return beams), which enter the microscopic optical element 51 from the light guide plate 4R, by the rear surface 5e, the traveling direction of the return beams can be changed into the direction of the liquid crystal display panel 10. In this way, the beams totally reflected internally by the rear surface 5e are projected in the direction of the liquid crystal display panel 10 and transmit through the light guide plate 4R, and then are transformed into beams having a light distribution necessary for being transformed into the illumination beams 13 having the narrow-angle light distribution by totally reflected internally by the microscopic optical element 50 of the downward prism sheet 5D. Thus, increased can be the ratio of light quantity of the illumination beams 13 that are projected from the first backlight unit 16 and that have the narrow-angle light distribution to light quantity projected from the light source 3C configuring the first backlight unit 16 (the ratio is defined as efficiency for light utilization of the first backlight unit 16). Therefore, since the light quantity of the light source necessary for ensuring predetermined brightness at the display surface 10a can be decreased compared to that of a conventional device, power consumption of the liquid crystal display device 200 can be reduced.

Next, a configuration of the second backlight unit 17 will be described. As shown in FIGS. 29 and 30, the second backlight unit 17 includes a casing 21, and the light sources 19 of light-emitting diodes, etc. provided in the casing 21. The light sources 19 are regularly-arranged along the X-Y plane so as to be provided immediately below the liquid crystal display panel 10. Both inner surfaces of the side walls in the Y-axis direction and the inner surface of a bottom plate portion of the casing 21 are diffusion reflection surfaces. A diffusion transmission plate 22 for diffusely transmits the beams projected from the light sources 19 is provided at the front surface (surface in liquid crystal display panel 10 side) of the casing 21. The diffusion transmission plate 22 is made of a material having high diffusivity, so as to ensure planar uniformity of the illumination beams 14. In this way, the second backlight unit 17 is configured as a backlight having light sources at its bottom.

This second backlight unit 17 is effective as a backlight unit that emits the illumination beams 14 having the wide-angle light distribution and that are also required a large luminescence amount. For example, even if the screen size of the liquid crystal display device 200 is enlarged, sufficient brightness can be ensured using the second backlight unit 17 having light sources at its bottom.

When using the second backlight unit 17 having light sources at its bottom, a complicated structure is necessary for equalizing the light distribution of the illumination beams 14 if a laser light source whose luminescence area is small and that has high directivity is used as the light sources 19. Therefore, in Embodiment 7, it is desirable that a light-emitting diode is used as the light source of the second backlight unit 17, whose luminescence is easily controllable similar to the laser light source and in which the light distribution of the illumination beams 14 is easily equalized thanks to its planar emission characteristics. Thus, because the second backlight unit 17 can be configured simply, further cost reduction can be achieved.

As the light source 3C in the first backlight unit 16 and the light sources 19 in the second backlight unit 17, it is desirable to employ a light source having the same luminescence system. The reason is that, when the viewing angle is modified by changing the percentage of the luminescence amount of the first backlight unit 16 and the luminescence amount of the second backlight unit 17, possibility can be avoided in which luminescence color change etc. is generated, caused by the difference of luminescence characteristics (emission spectrum, etc.) between the light sources 3C and 19.

In a liquid crystal display device having the above-described variable viewing angle function, the decrease in peripheral brightness also happens as the viewpoint changes, as described above. Therefore, in the liquid crystal display device 100, the light distribution control member 83 in Embodiment 1 is provided between the backlight unit 1 and the liquid crystal display panel 10. Thus, in the liquid crystal display device having the variable viewing angle function, the decrease in peripheral brightness due to the change in the viewing distance can be reduced even if the viewing angle is narrowed.

As described above, in the liquid crystal display device 200 in Embodiment 7, similar to the liquid crystal display device 100 in Embodiment 6, the viewing angle can be controlled by adjusting the percentage of the luminescence amount of the first backlight unit 16 and the luminescence amount of the second backlight unit 17, without using complicated and expensive active optical devices. In the liquid crystal display device 200, since the beams projected from the display surface 10a in the unnecessary direction can be minimized, the viewing angle control function effective for reducing the power consumption can be obtained. Also, the liquid crystal display device 200 has a configuration that is simple and low-cost, and that is effective without depending on the screen size, i.e. from small through large size.

In addition, similar to the liquid crystal display device 100 in Embodiment 6, since the first backlight unit 16 has the upward prism sheet 5V, the return beams projected from the light guide plate 4R in the rear surface direction thereof in the first backlight unit 16 are totally reflected internally by the rear surface 5e due to the microscopic optical element 51 of the upward prism sheet 5V, thereby becoming the illumination beams 13 having the narrow-angle light distribution. Thus, the return beams can be utilized as the emission beams of the first backlight unit 16. Therefore, in the liquid crystal display device of backlight laminating type in Embodiment 7, the efficiency for light utilization of the first backlight unit 16 can be also improved without the loss of the emission beams 14 from the second backlight unit 17.

Furthermore, in the liquid crystal display device 200, since the second backlight unit 17 for emitting the illumination beams 14 having the wide-angle light distribution is configured as a backlight having light sources at its bottom, enlarging the screen size and reducing the power consumption of the liquid crystal display device 200 having the viewing angle control function can be achieved with low cost.

Note that, while the light distribution control member in Embodiment 1 is used as the light distribution control member 83 in Embodiment 7, the configuration is not limited to this. Any one of the light distribution control members in Embodiments 2 through 5, or a variant thereof can be employed.

### Variants of Embodiments 6 and 7

In the above, while different embodiments according to the present invention have been described with reference to the drawings, these are exemplifications of the present invention and various configurations other than the above can be employed. For example, while the shape of the microscopic optical element 50 is the triangular prism as shown in FIG. 19, the shape is not limited thereto. As described above, the shape of the microscopic optical element 50 is to be determined by the combination with the light guide plate 4. A shape other than the triangular prism can be employed as long as a principal ray of beams that is projected from the front surface 4b of the light guide plate 4 and that enters the downward prism sheet 5D can be transformed into the illumination beams 11 having the narrow-angle light distribution by totally reflected internally by the microscopic optical element 50.

In addition, while the upward prism sheet 5V, for example, has the microscopic optical element 51 having a convex triangular prism shape as shown in FIG. 22, the shape is not limited thereto. Employed may be an optical sheet or a plate-like member having another microscopic optical element, that does not have a structure at a plane (Y-Z plane in the figure) in which the microscopic optical element 50 of the downward prism sheet 5D has the slanted portion, but that has a structure at a plane (Z-X plane in the figure) orthogonal to the Y-Z plane. However, since the beams projected from the second backlight unit 2 transmit through the optical sheet or the plate-like member, the structure should be provided under the consideration that the beams are optically affected at the Z-X plane in the figure. The upward prism sheet 5V in Embodiments 4 and 5 has a structure for condensing the beams from the second backlight unit 2 in the direction perpendicular to the viewing angle control direction. Thus, since the light distribution in the direction in which the wide viewing angle is unnecessary is narrowed, it is possible to achieve effects such as the increase in brightness or the reduction in power consumption.

Furthermore, while the liquid crystal display devices 100 and 200 in Embodiments 6 and 7 has the upward prism sheet 5V, an embodiment that does not have the upward prism sheet 5V may be feasible. In addition, in the first backlight units 1 and 16 in Embodiments 6 and 7, while a preferable configuration is employed in which the arranging direction of the microscopic optical elements 51 of the upward prism sheet 5V is almost orthogonal to the arranging direction of the microscopic optical elements 50 of the downward prism sheet 5D as described above, the configuration in the present invention is not limited thereto. Even in a case when an angle formed between the arranging direction of the microscopic optical elements 51 and the arranging direction of the microscopic optical elements 50 is shifted from 90 degrees by a certain amount, efficiency for light utilization of the first backlight units 1 and 16 can be improved compared to the embodiment in which the upward prism sheet 5V is not provided.

As described above, in the liquid crystal display devices 100 and 200 in Embodiments 6 and 7, a finely-tuned viewing angle control can be made regardless of the size. Thus, since an optimum viewing angle can be selected in accordance with the number and positions of observers, the effect for reducing power consumption can be obtained by employing lean illumination. Also, while this function is utilized in improving visibility from the observers and their surroundings with a wide viewing angle display in a normal mode, the function can be also employed as an application for creating a private mode in which the display portion cannot be observed from the surroundings by changing to a narrow viewing angle display.

### Embodiment 8

FIG. 31 is a cross-sectional view enlargedly showing a part of a light distribution control member in a liquid crystal display device in Embodiment 8, and (a) through (c) in FIG. 31 show the central portion 110, intermediate portion, and peripheral portion of the light distribution control member 83, respectively. In the light distribution control member 83 in Embodiment 8, the concave 109 shown in FIG. 5 in Embodiment 1 is replaced by a convex 209. Since the configuration other than this replacement is similar to that in Embodiment 1, the explanation thereof will be skipped.

While the emission surface 83b of the central portion 110A in (a) in FIG. 31 has a planar shape, the convexes 209 are formed on the emission surfaces 83b of the intermediate portion 110B in (b) in FIG. 31 and the peripheral portion 110C in (c) in FIG. 31. The curvature radius of the convex 209 at the peripheral portion 110C in (c) in FIG. 31 is smaller than that at the intermediate portion 110B in (b) in FIG. 31. Note that, while radiuses are shown here only at three areas, i.e. central, intermediate, and peripheral portions 110A, 110B, and 110C, the curvature radiuses of the convexes 209 are formed, including the other areas, to be decreasing as coming close to the peripheral portion 110C.

Since the emission surface 83b of the light distribution control member 83 has the planar shape at the central portion 110A, the beam that is projected from the downward prism sheet 82 and that has the narrow-angle light distribution is projected from the light distribution control member 83 without changing its light distribution. At the intermediate portion 110B, since the convex 209 having a certain curvature radius is provided on the emission surface 83b, the beam that is projected from the downward prism sheet 82 and that has the narrow-angle light distribution is once condensed by the convex 209 and then again diffused, thereby being projected from the light distribution control member 83 with its light distribution broadened. At the peripheral portion 110C, since the convex 209 having a smaller curvature radius is provided, the beam that is projected from the downward prism sheet 82 and that has the narrow-angle light distribution is projected from the light distribution control member 83 with its light distribution more broadened.

As a result, the beams that are projected from the optical member 107 and that have the narrow-angle light distribution are transformed into beams whose light distributions are gradually broadened as moving on from the central portion toward the peripheral portion of the liquid crystal display panel 106, and the transformed beams are projected from the light distribution control member 83. That is, the percentage of an emission component having a slant angle from the Z-axis gradually increases as moving on from the central portion toward the peripheral portion of the liquid crystal display panel 106. As a result, similar to the case in Embodiment 1, the decrease in brightness at the peripheral portion can be alleviated when observed from any viewpoint located between the infinite distance and the short distance.

In the liquid crystal display device in Embodiment 8, the light distribution control member 83 is provided, for receiving the beams that are projected from the optical member 107 and that have the narrow-angle light distribution and for projecting the beams in the direction of the liquid crystal display panel 106; the plural convexes 209 are provide on the light distribution control member 83; and the curvature radiuses of the plural convexes 209 are formed to be decreasing as coming close to the peripheral portion 110C of the light distribution control member 83. Therefore, since the beams that have the narrow-angle light distribution are transformed into beams whose light distributions are gradually broadened as moving on from the central portion toward the peripheral portion of the liquid crystal display panel 106, the decrease in brightness at the peripheral portion can be alleviated when observed from any viewpoint located between the infinite distance and the short distance.

When providing a concave on the light distribution control member 83, it is necessary to fabricate a convex metal mold for manufacturing the concave using the molding, and when providing a convex on the light distribution control member 83, it is necessary to fabricate a concave metal mold for manufacturing the convex using the molding. In Embodiment 8, since fabricating a convex metal mold is more difficult than fabricating a concave one, the light distribution control member 83 can be manufactured easier compared to the case for providing a concave. Note that a convex can be provided more easily if an inkjet method using the surface tension of resin, etc. is used.

### Embodiment 9

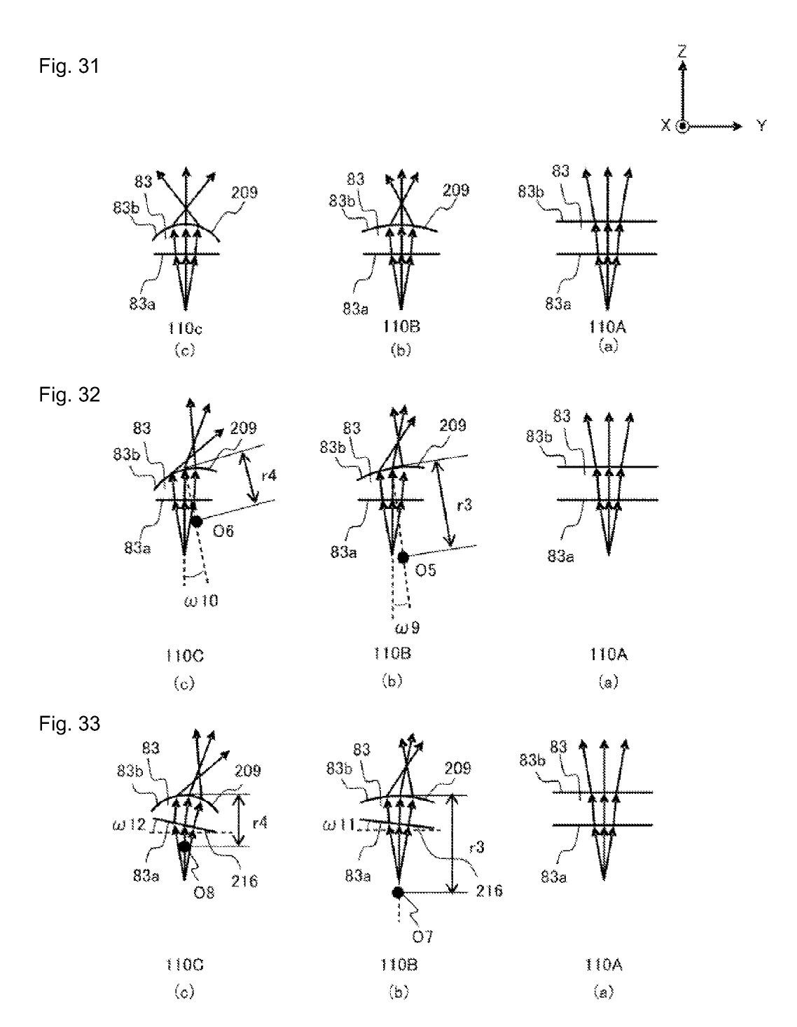

FIG. 32 is a cross-sectional view enlargedly showing a part of a light distribution control member in a liquid crystal display device in Embodiment 9, and (a) through (c) in FIG. 32 show the central portion, intermediate portion, and peripheral portion of the light distribution control member, respectively.

As shown in FIG. 32, the liquid crystal display device in Embodiment 9 has a configuration in which plural convexes 209 are provided on the light distribution control member 83, similar to that in Embodiment 8. However, while the direction of the peak component of the beams projected from the light distribution control member 83 is parallel to the normal direction of the liquid crystal display panel 106 in Embodiment 8, the difference in Embodiment 9 is that the convexes 209 are slanted against the normal direction of the display surface so that the direction of the peak component of the beams projected from the light distribution control member 83 will be directed to the normal line passing through the central portion of the display surface of the liquid crystal display panel. Since the configuration other than this arrangement is similar to that in Embodiment 8, the explanation thereof will be skipped.

While the emission surface 83b of the central portion 110A in (a) in FIG. 32 is a planar shape, the convexes 209 are formed on the emission surfaces 83b of the intermediate portion 110B in (b) in FIG. 32 and the peripheral portion 110C in (c) in FIG. 32. The convex 209 at the intermediate portion 110B has a curvature radius of r3, and is slanted by ω9 against the Z-axis, which is the normal direction of the display surface 106b, in the direction of the peripheral portion of the light distribution control member. That is, a straight line connecting the center point and the curvature center O5 of the convex 209 forms the angle ω9 against the Z-axis. The convex 209 at the peripheral portion 110C has a curvature radius of r4, and is slanted by ω10 against the Z-axis in the direction of the peripheral portion of the light distribution control member. That is, a straight line connecting the center point and the curvature center O6 of the convex 209 forms the angle ω10 against the Z-axis. The curvature radius r4 is smaller than r3, and the slant angle ω10 of the convex 209 is larger than ω9. While configurations are shown here only at three areas, i.e. central, intermediate, and peripheral portions 110A, 110B, and 110C, the curvature radius of the convex 209 decreases as coming close to the peripheral portion 110C, and the slant angle of the convex 209 increases as coming close to the peripheral portion 110C.

Since the emission surface 83b of the light distribution control member 83 is a planar shape at the central portion 110A, a beam that is projected from the downward prism sheet 82 and that has a narrow-angle light distribution is projected from the light distribution control member 83 without changing its light distribution. Because the convex 209 having the curvature radius of r3 is provided on the emission surface 83b at the intermediate portion 110B and the convex 209 is slanted by ω9 against the Z-axis in the direction of the peripheral portion of the light distribution control member 83, a distribution of a beam that is projected from the downward prism sheet 82 and that has the narrow-angle light distribution is broadened in the Y-axis direction and, at the same time, the direction of the peak component of the beam is slanted to be directed to the normal line passing through the central portion of the display surface 106b of the liquid crystal display panel 106, thereby being slanted as a whole in the direction of the central portion.

Since the convex 209 having the curvature radius of r4, which is smaller than the above-described curvature radius of r3, is provided at the peripheral portion 110C and the convex 209 is slanted by ω10, which is larger than ω9, against the Z-axis in the direction of the peripheral portion of the light distribution control member, a distribution of a beam that is projected from the downward prism sheet 82 and that has the narrow-angle light distribution is more broadened in the Y-axis direction compared to the above-described case in the intermediate portion 110B and, at the same time, the direction of the peak component of the beam is further slanted to be directed to the normal line passing through the central portion of the display surface 106b of the liquid crystal display panel 106, compared to the above-described case in the intermediate portion 110B.

As a result, the beams that are projected from the optical member 107 and that have the narrow-angle light distribution are projected from the light distribution control member 83 so that the light distributions thereof are gradually broadened as moving on from the central portion toward the peripheral portion of the liquid crystal display panel 106; the direction of the peak component of the beams is slanted to be directed to the central portion of the display surface 106b of the liquid crystal display panel 106; and the projected beams have increased component projected in the direction of the normal line passing through the central portion of the display surface 106b of the liquid crystal display panel 106 as moving on to the peripheral portion 110C of the light distribution control member 83.

Therefore, similar to the case in Embodiment 3, since the beams that are projected from the optical member 107 and that have the narrow-angle light distribution are transformed so as to have the broadened light distribution using the light distribution control member 83, and the beams are also transformed so that the direction of the peak component thereof is slanted to be directed to the normal line passing through the central portion of the display surface 106b of the liquid crystal display panel 106, the decrease in brightness at the peripheral portion can be alleviated when observed from any viewpoint located between the infinite distance and the short distance.

In the backlight in Embodiment 9, since the convex 209 is slanted against the normal direction of the display surface 106b so that the direction of the peak component of the beams projected from the light distribution control member 83 will be slanted to be directed to the normal line passing through the central portion of the display surface 106b of the liquid crystal display panel 106, the decrease in brightness at the peripheral portion can be further alleviated in addition to the effect in Embodiment 8.

### Embodiment 10

FIG. 33 is a cross-sectional view enlargedly showing a part of a light distribution control member in a liquid crystal display device in Embodiment 10, and (a) through (c) in FIG. 33 show the central portion, intermediate portion, and peripheral portion of the light distribution control member, respectively. In Embodiment 9, a configuration is shown in which the convexes 209 are slanted against the normal line of the display surface 106b so that the peak component of the beams projected from the light distribution control member 83 will be slanted to be directed to the normal line passing through the central portion of the display surface 106b of the liquid crystal display panel 106. On the other hand, the convexes 209 may be provided on the emission surface 83b and at the same time, slanted planes 216 opposite to the convexes 209 may be provided on the incident surface 83a. Also in this configuration, the direction of the peak component of the beams projected from the light distribution control member 83 can be directed to the central portion of the display surface 106b of the liquid crystal display panel 106. Since the configuration, except the shape of the light distribution control member 83, is similar to that in Embodiment 9, the explanation thereof will be skipped.

While the incident surface 83a and emission surface 83b of the central portion 110A in (a) in FIG. 33 are planar shapes, the convexes 209 are formed on the emission surfaces 83b and, at the same time, the slanted planes 216 opposite to the convexes 209 are formed on the incident surfaces 83a at the intermediate portion 110B in (b) in FIG. 33 and the peripheral portion 110C in (c) in FIG. 11. The convex 209 having a curvature radius of r3 is formed on the emission surface 83b at the intermediate portion 110B, and a straight line connecting the center point and the curvature center O7 of the convex 209 is parallel to the Z-axis. The slanted plane 216 opposite to the convex 209 is formed on the incident surface 83a, and the slanted plane 216 is slanted by ω11 against the X-axis and Y-axis, which are in parallel direction to the liquid crystal display panel 106, in the direction of the peripheral portion of the light distribution control member 83.

The convex 209 having a curvature radius of r4 is formed on the emission surface 83b at the peripheral portion 110C, and a straight line connecting the center point and the curvature center O8 of the convex 209 is parallel to the Z-axis. The slanted plane 216 opposite to the convex 209 is formed on the incident surface 83a, and the slanted plane 216 is slanted by ω12 against the X-axis and Y-axis, which are in parallel direction to the liquid crystal display panel 106, in the direction of the peripheral portion of the light distribution control member 83. The curvature radius r4 is smaller than r3, and the slant angle ω12 is larger than ω11. While configurations are shown here only at three areas, i.e. central, intermediate, and peripheral portions 110A, 110B, and 110C, the curvature radius of the convex 209 is formed to be decreasing as coming close to the peripheral portion 110C, and the slant angle of the slanted plane 216 is formed to be increasing as coming close to the peripheral portion 110C, including the other areas.

Since the incident surface 83a and emission surface 83b of the light distribution control member 83 are planar shapes at the central portion 110A, a beam that is projected from the downward prism sheet 82 and that has a narrow-angle light distribution is projected from the light distribution control member 83 without changing its light distribution. Because the convex 209 having the curvature radius of r3 is provided on the emission surface 83b and the slanted plane 216 slanted by ω11 against the X-axis and Y-axis is formed on the incident surface 83a at the intermediate portion 110B, the direction of the peak component of a beam that is projected from the downward prism sheet 82 and that has the narrow-angle light distribution is directed, by the slanted plane 216 on the incident surface 83a, to the normal line passing through the central portion of the display surface 106b of the liquid crystal display panel 106, and a distribution of the beam is broadened in the Y-axis direction by the convex 209 on the emission surface 83b.

Since the convex 209 having the curvature radius of r4, which is smaller than the above-described curvature radius of r3, is provided on the emission surface 83b and the slanted plane 216 slanted by ω12, which is larger than the above-described slant angle ω11, against the X-axis and Y-axis is formed on the incident surface 83a at the peripheral portion 110C, a beam that is projected from the downward prism sheet 82 and that has the narrow-angle light distribution is more slanted compared to the above-described case in the intermediate portion 110B by the slanted plane 216 on the incident surface 83a, and a distribution of the beam is more broadened, by the convex 209 on the emission surface 83b, in the Y-axis direction compared to the above-described case in the intermediate portion 110B. As a result, the beams that are projected from the optical member 107 and that have the narrow-angle light distribution are transformed so that the light distributions thereof are gradually broadened as moving on from the central portion toward the peripheral portion of the liquid crystal display panel 106 and that the direction of the peak component thereof is directed to the normal line passing through the central portion of the display surface 106b of the liquid crystal display panel 106, and the transformed beams are projected from the light distribution control member 83. Therefore, the decrease in brightness at the peripheral portion can be alleviated when observed from any viewpoint located between the infinite distance and the short distance.

In the backlight in Embodiment 10, since the plural convexes 209 are provided on the emission surface 83b and, at the same time, the plural slanted planes 216 opposite to the plural convexes 209 are provided on the incident surface 83a of the light distribution control member 83, and the slanted planes 216 are formed so that the direction of the peak component of the beams projected from the light distribution control member 83 will be directed to the normal line passing through the central portion of the display surface 116b of the liquid crystal display panel 116, the effect similar to that in Embodiment 9 can be obtained.

Note that, while a configuration is shown here in which the plural slanted planes 216 are provided on the incident surface 83a and the plural convexes 209 are provided on the emission surface 83b, the similar effect can be obtained when the plural convexes 209 are provided on the incident surface 83a and the plural slanted planes 216 are provided on the emission surface 83b.

The embodiments and variants thereof described above can be mutually combined.

### REFERENCE NUMERALS

100, 200: liquid crystal display devices; 108: backlight; 1, 16: first backlight units; 2, 17, 18: second backlight unit; 3A, 3B, 6A, 6B, 3C, 19, 60, 117A, and 117B: light sources; 60L: lens; 4, 4R, and 81: light guide plates; 40, 40R, 50, 51, and 81a: microscopic optical elements; 5D, 82: downward prism sheets (optical sheets); 107: optical member; 83: light distribution control member; 109: concave; 209: convex; 116, 216: slanted planes; 1000: optical surface; 103a: first surface; 103b: second surface; 103c: third surface; 5V: upward prism sheet; 7: light guide plate; 70: diffusion reflection structure; 8, 80: light reflection sheets; 9: optical sheet; 10, 106: liquid crystal display panels; 21, 61: casings; 22, 62: diffusion transmission plates (diffusion transmission structure): and P, Q, and R: viewing points.

1. A backlight comprising:
a light source;
an optical member for transforming beams projected from the light source into beams having a narrow-angle light distribution in which rays having intensity of no less than a predetermined value are localized within a predetermined angle range centered in the normal direction of a display surface of a liquid crystal display panel, and for projecting the transformed beams in the direction of the liquid crystal display panel; and
a light distribution control member for receiving the beams that are projected from the optical member and that have the narrow-angle light distribution, and for projecting the received beams in the direction of the liquid crystal display panel, wherein
a plurality of curved surfaces are provided at the light distribution control member for each transforming a beam, from among the beams having the narrow-angle light distribution, that enters a peripheral portion of the liquid crystal display panel so that the narrow-angle light distribution of the entered beam is broadened compared to that of a beam that enters a central portion of the liquid crystal display panel; and
curvature radiuses of the plurality of curved surfaces are formed so that a curvature radius of a curved surface located at a peripheral portion of the light distribution control member is smaller than a curvature radius of a curved surface located at a central portion of the light distribution control member.

2. The backlight in claim 1, wherein the curvature radiuses of the plurality of curved surfaces are formed to be decreasing as coming close to the peripheral portion of the light distribution control member so that the narrow-angle light distribution is gradually broadened as moving on from the central portion toward the peripheral portion of the liquid crystal display panel.

3. The backlight in claim 1, wherein the plurality of curved surfaces are slanted against the normal direction of the display surface so that the direction of a peak component of the beams projected from the light distribution control member is directed to a normal line passing through the central portion of the display surface of the liquid crystal display panel.

4. The backlight in claim 3, wherein a slant angle of the plurality of curved surfaces increases as coming close to the peripheral portion of the light distribution control member.

5. The backlight in claim 1, wherein the plurality of curved surfaces are provided at either one of an incident surface or an emission surface of the light distribution control member; a plurality of slanted planes opposite to the plurality of curved surfaces are provided at the other surface; and the plurality of slanted planes are formed so that the direction of the peak component of the beams projected from the light distribution control member is directed to the normal line passing through the central portion of the display surface of the liquid crystal display panel.

6. The backlight in claim 5, wherein a slant angle of the plurality of slanted planes increases as coming close to the peripheral portion of the light distribution control member.

7. The backlight in claim 1, wherein the curved surface is configured with a concave or a convex.

8. A backlight comprising:
a light source;
an optical member for transforming beams projected from the light source into beams having a narrow-angle light distribution in which rays having intensity of no less than a predetermined value are localized within a predetermined angle range centered in the normal direction of a display surface of a liquid crystal display panel, and for projecting the transformed beams in the direction of the liquid crystal display panel; and
a light distribution control member for receiving the beams that are projected from the optical member and that have the narrow-angle light distribution, and for projecting the received beams in the direction of the liquid crystal display panel, wherein
a plurality of optical surfaces are provided at the light distribution control member so that the direction of a peak component of the beams having the narrow-angle light distribution is transformed to be directed to directions of at least two viewing points; and
the plurality of optical surfaces include a first surface for directing the direction of the peak component of the beams having the narrow-angle light distribution in a first viewing point located on a normal line passing through a central portion of the display surface of the liquid crystal display panel, and includes a second surface for directing the direction of the peak component of the beams having the narrow-angle light distribution in a second viewing point located on the normal line passing through the central portion of the display surface of the liquid crystal display panel and located differently from the first viewing point.

9. The backlight in claim 8, wherein each of the first surface and the second surface is configured with a planar shape.

10. The backlight in claim 9, wherein the first surface and the second surface are slanted by mutually different angles against the direction parallel to the display surface of the liquid crystal display panel.

11. The backlight in claim 10, wherein each of slant angles of the first surface and the second surface increases as coming close to a peripheral portion of the light distribution control member.

12. The backlight in claim 8, wherein the width of the optical surface is equal to or less than the width of a picture element for configuring a pixel of the liquid crystal display panel.

13. The backlight in claim 1, wherein the optical member includes a light guide plate for projecting the beams, which are projected from the light source, in the direction of the liquid crystal display panel by internally reflecting the beams by a rear surface of the plate located in the opposite direction of the liquid crystal display panel side; and includes an optical sheet for transforming the beams projected from the light guide plate in the direction of the liquid crystal display panel into beams having the narrow-angle light distribution.

14. The backlight in claim 13, wherein a plurality of microscopic optical elements, that protrude in the opposite direction of the liquid crystal display panel side and that internally reflect the beams projected from the light source, are provided at the rear surface of the light guide plate; and the microscopic optical elements are provided so that the beam projected from the light guide plate is increased as coming close to a peripheral portion of the light guide plate.

15. A liquid crystal display device comprising:
a liquid crystal display panel that has a rear surface and a display surface opposite to the rear surface, that generates image light by modulating beams that enter from the rear surface, and that projects the image light from the display surface; and
the backlight in claim 1.

16. A liquid crystal display device comprising:
a liquid crystal display panel that has a rear surface and a display surface opposite to the rear surface, that generates image light by modulating beams that enter from the rear surface, and that projects the image light from the display surface;
the backlight in claim 1;
a second backlight for projecting beams toward a rear surface of the backlight;
a first light source driving control unit for controlling a luminescence amount of the backlight; and
a second light source driving control unit for controlling a luminescence amount of the second backlight, wherein
the light source of the backlight is controlled by the first light driving control unit;
the second backlight unit includes a second light source controlled by the second light source driving control unit, and includes a second optical member that transforms the beams projected from the second light source into beams having a wide-angle light distribution in which rays having intensity of no less than a predetermined value are localized within a second predetermined angle range wider than the predetermined angle range at the narrow-angle light distribution, and that projects the transformed beams toward the rear surface of the backlight; and
the optical member transmits the beams projected from the second optical member without narrowing the wide-angle light distribution.
